(19) United States
(12) Patent Application Publication
(10) Pub. No.: US 2025/0141340 A1
(43) Pub. Date: May 1, 2025

(54) POWER CONVERTING APPARATUS, MOTOR DRIVE UNIT, AND REFRIGERATION CYCLE-INCORPORATING APPARATUS

(71) Applicant: Mitsubishi Electric Corporation, Tokyo (JP)

(72) Inventors: Haruka MATSUO, Tokyo (JP); Tomohiro KUTSUKI, Tokyo (JP); Takaaki TAKAHARA, Tokyo (JP); Koichi ARISAWA, Tokyo (JP); Yuki TANIYAMA, Tokyo (JP)

(21) Appl. No.: 18/690,958

(22) PCT Filed: Oct. 28, 2021
(86) PCT No.: PCT/JP2021/039878

§ 371 Date: Mar. 11, 2024

(51) Int. Cl. H02M 1/12; H02M 1/14; H02M 1/44; H02M 5/458; H02P 27/06

(52) U.S. Cl. CPC H02M 1/12; H02M 1/14; H02M 1/44; H02M 5/458; H02P 27/06

(57) ABSTRACT

A power converting apparatus includes a rectifier unit that rectifies first alternating-current power supplied from a commercial power supply, a capacitor connected to an output end of the rectifier unit, an inverter connected across the capacitor to generate second alternating-current power and output the second alternating-current power to a motor, and a control unit that controls an operation of the inverter and an operation of the motor using a dq-rotational coordinate system rotating in synchronization with a rotor position of the motor. The control unit extracts multiple frequency components from a q-axis current pulsation, which is a pulsatile component of a q-axis current, and limits the amplitude value of each of the extracted frequency components to control the amplitude of the q-axis current pulsation.

### CROSS-REFERENCE TO RELATED APPLICATION

This application is a U.S. National Stage Application of PCT/JP2021/039878 filed on Oct. 28, 2021, the contents of which are incorporated herein by reference.

### FIELD

The present disclosure relates to a power converting apparatus for converting alternating-current (AC) power into desired power, and to a motor drive unit and a refrigeration cycle-incorporating apparatus.

### BACKGROUND

Motors are used nowadays as power sources for various mechanical devices. Many of mechanical devices experience a periodical fluctuation of load torque, that is, a periodical load torque pulsation. A load torque pulsation may cause vibration, noise, etc. in a motor, a mechanical device, etc. As such, various technologies related to vibration reducing control have been studied. For example, Patent Literature 1 discloses a technology for a motor drive unit to reduce vibration by performing a compensation operation of adding to the q-axis current a pulsatile component for reducing the vibration.

For a typical power converting apparatus for use in a motor drive unit as described above, a rectifier unit rectifies AC power supplied from an AC power supply, a smoothing capacitor then smooths the rectified power, an inverter defined by multiple switching elements converts the smoothed power into desired AC power, and outputs the AC power to a motor. For a power converting apparatus configured as described above, a large flow of current into the smoothing capacitor provides faster aging degradation of the smoothing capacitor. A conceivable way to address such problems is to reduce ripple fluctuation in the capacitor voltage by increasing the capacity of the smoothing capacitor. Another way is to use a smoothing capacitor having higher resistance to degradation due to ripple. However, these ways will increase cost of capacitor components, and increase the size of the apparatus. To prevent the up-sizing of the apparatus as well as to reduce the degradation of the smoothing capacitor, thus, the power converting apparatus performs a compensation operation of causing the q-axis current to pulsate so as to reduce the current flowing to the smoothing capacitor.

### PATENT LITERATURE

Patent Literature 1: Japanese Patent Application Laid-open No. 2017-55466

For capacitor current reducing control, the q-axis current pulsates for a frequency twice the frequency of an AC power supplied from an AC power supply because an AC power rectified by the rectifier unit pulsates at a frequency twice the frequency of the AC power supplied from the AC power supply. Unfortunately, the control, which is intended for only the frequency twice the frequency of the AC power supplied from the AC power supply, poses a problem of failure to provide a sufficient effect of the capacitor current reducing control where a pulsatile component of the current flowing to the smoothing capacitor includes higher frequency components such as components twice and three times the base frequency twice the frequency of the AC power. The same is true of the foregoing vibration reducing control where the higher frequency component is included. The compensation control that causes the q-axis current to pulsate is intended for various controls other than the capacitor current reducing control and the vibration reducing control described above.

### SUMMARY

The present disclosure has been made in view of the foregoing, and it is an object of the present disclosure to provide a power converting apparatus capable of increasing accuracy of compensation in compensation control that causes the q-axis current to pulsate.

To solve the above problem and achieve the object, a power converting apparatus according to the present disclosure comprises: a rectifier unit rectifying first alternating-current power supplied from a commercial power supply; a capacitor connected to an output end of the rectifier unit; an inverter connected across the capacitor, the inverter generating second alternating-current power and outputting the second alternating-current power to a motor; and a control unit controlling an operation of the inverter and an operation of the motor, using a dq-rotational coordinate system, the dq-rotational coordinate system rotating in synchronization with a rotor position of the motor. The control unit extracts a plurality of frequency components from a q-axis current pulsation and limits an amplitude value of each of the extracted frequency components to control an amplitude of the q-axis current pulsation, the q-axis current pulsation being a pulsatile component of a q-axis current.

A power converting apparatus according to the present disclosure provides an advantageous effect of increasing the accuracy of compensation in the compensation control that causes the q-axis current to pulsate.

### DETAILED DESCRIPTION

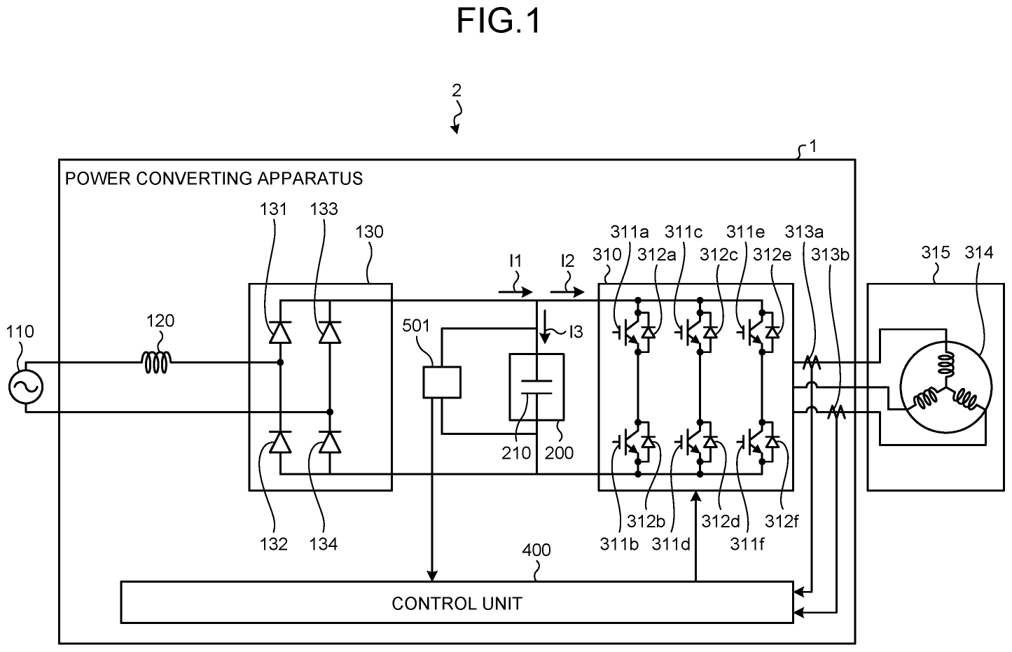

FIG. 1 is a diagram illustrating an example configuration of a power converting apparatus according to a first embodiment.

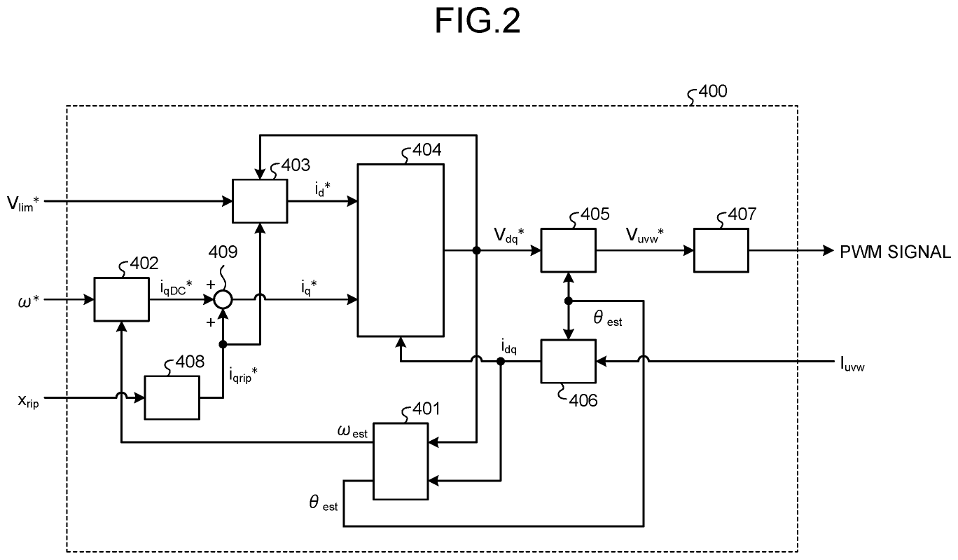

FIG. 2 is a block diagram illustrating an example configuration of a control unit of the power converting apparatus according to the first embodiment.

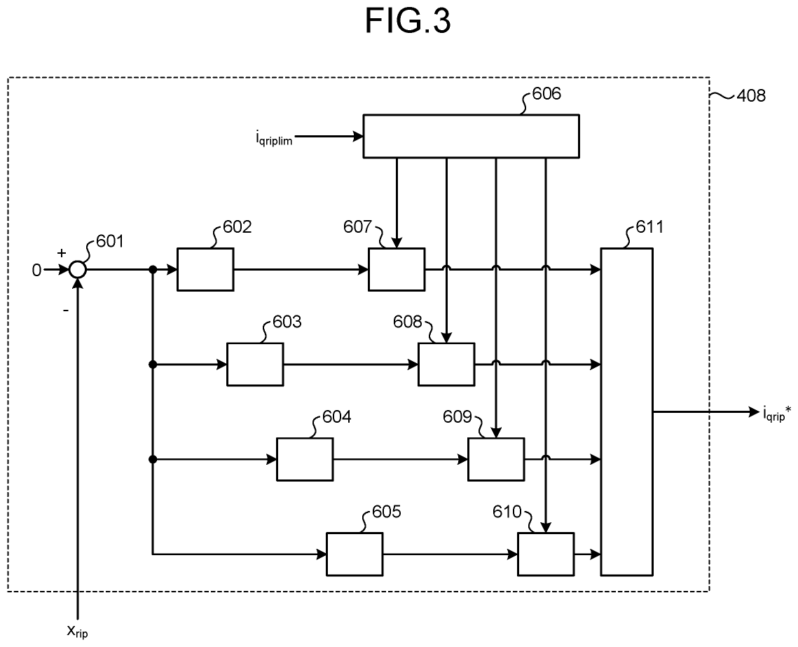

FIG. 3 is a block diagram illustrating an example configuration of a q-axis current pulsation computing unit of the control unit of the power converting apparatus according to the first embodiment.

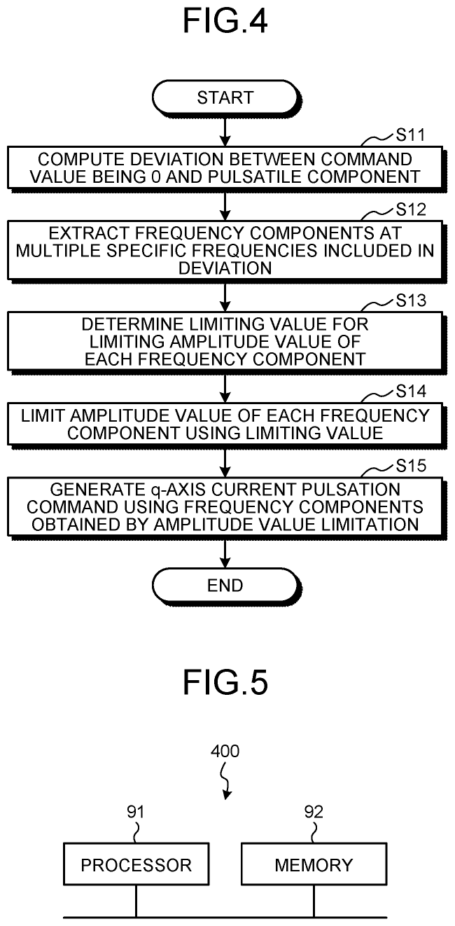

FIG. 4 is a flowchart illustrating an operation of the q-axis current pulsation computing unit of the control unit of the power converting apparatus according to the first embodiment.

FIG. 5 is a diagram illustrating an example of hardware configuration for implementing the control unit of the power converting apparatus according to the first embodiment.

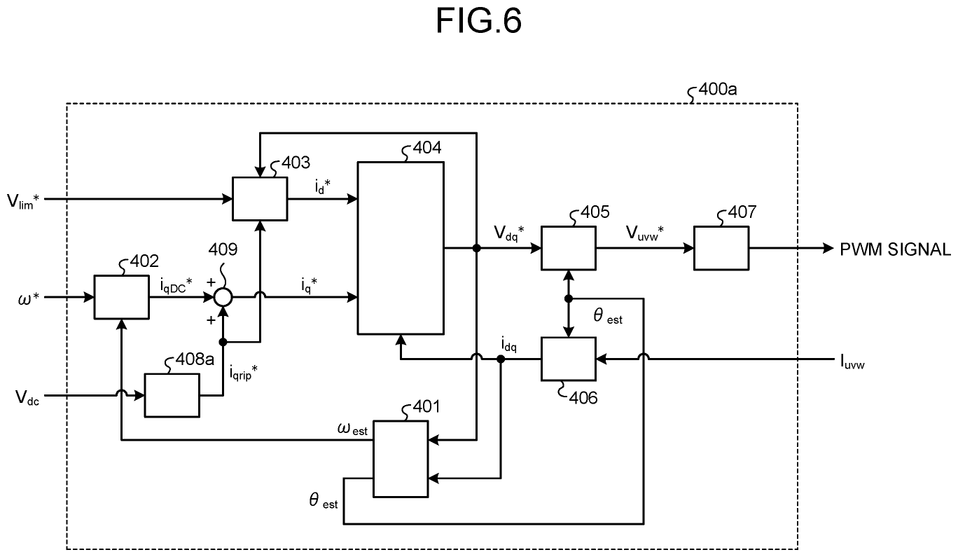

FIG. 6 is a block diagram illustrating an example configuration of a control unit of the power converting apparatus according to a second embodiment.

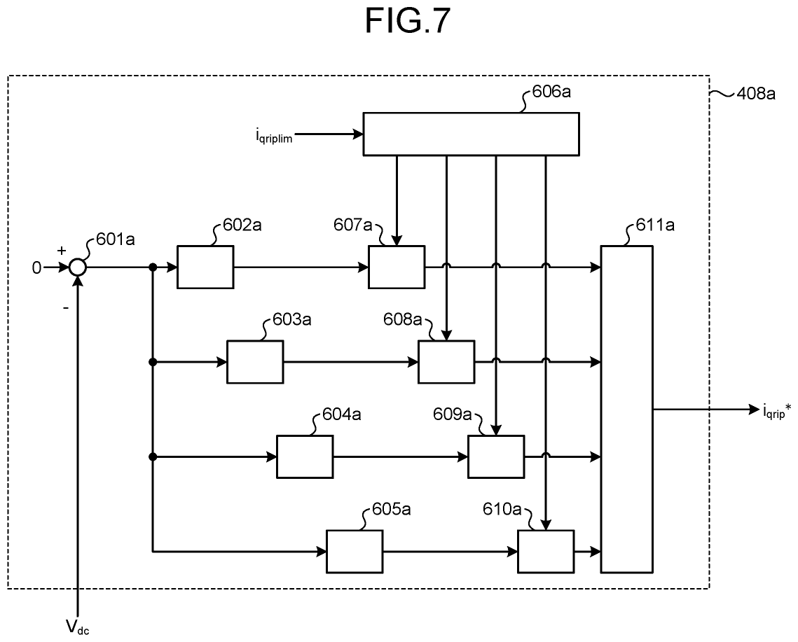

FIG. 7 is a block diagram illustrating an example configuration of a q-axis current pulsation computing unit of the control unit of the power converting apparatus according to the second embodiment.

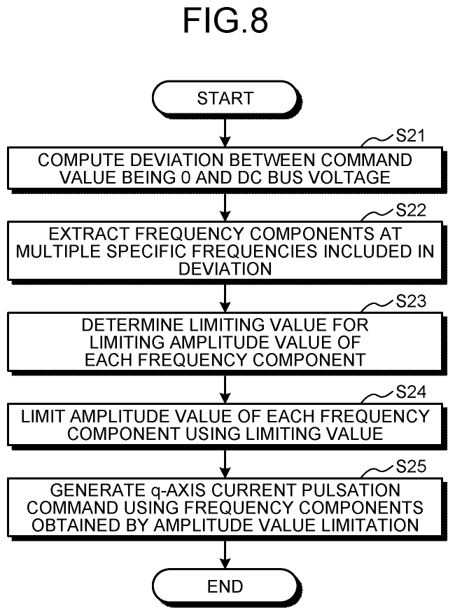

FIG. 8 is a flowchart illustrating an operation of the q-axis current pulsation computing unit of the control unit of the power converting apparatus according to the second embodiment.

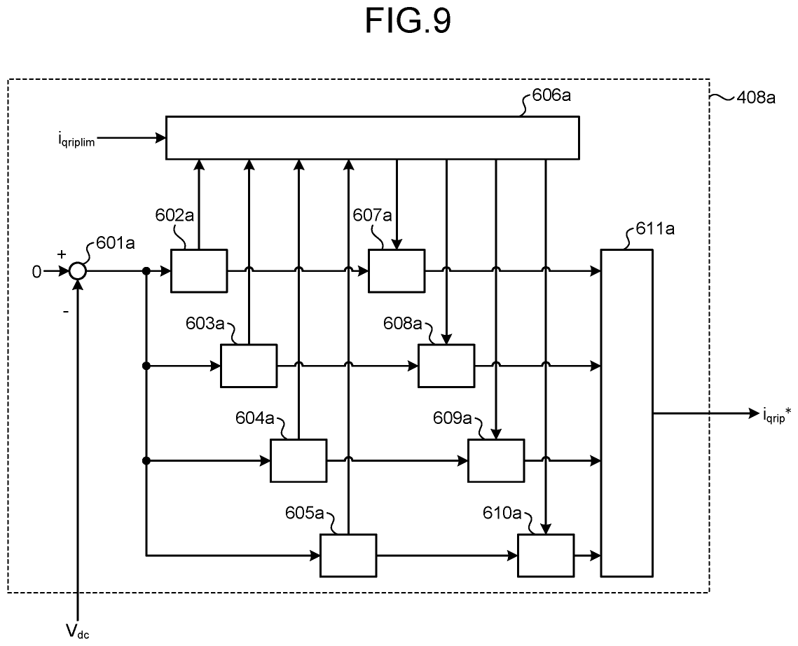

FIG. 9 is a first block diagram illustrating an example configuration of the q-axis current pulsation computing unit of the control unit of the power converting apparatus according to a third embodiment.

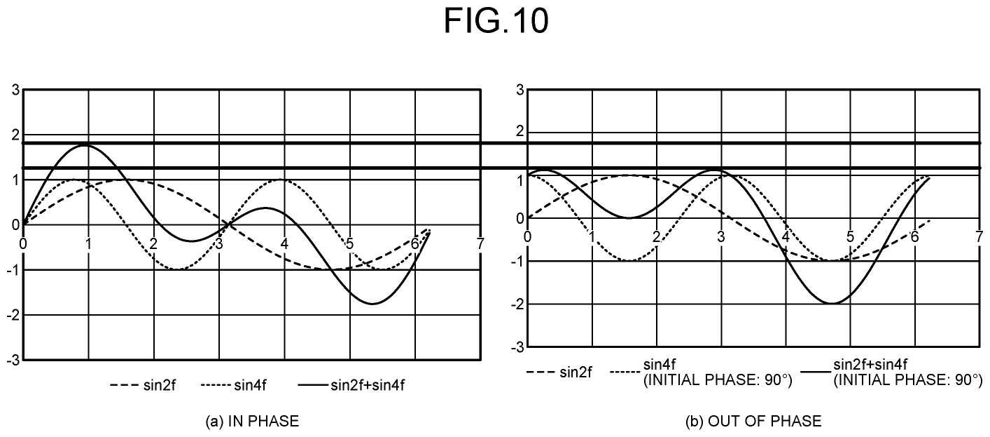

FIG. 10 is a diagram illustrating an example in which the peak value differs depending on the phase difference when two frequency components are added together.

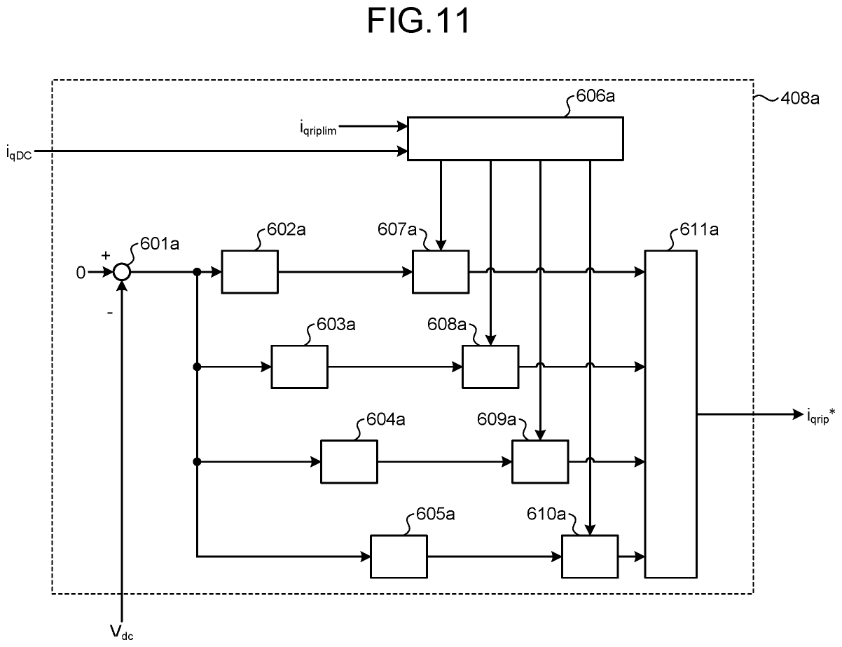

FIG. 11 is a second block diagram illustrating an example configuration of the q-axis current pulsation computing unit of the control unit of the power converting apparatus according to the third embodiment.

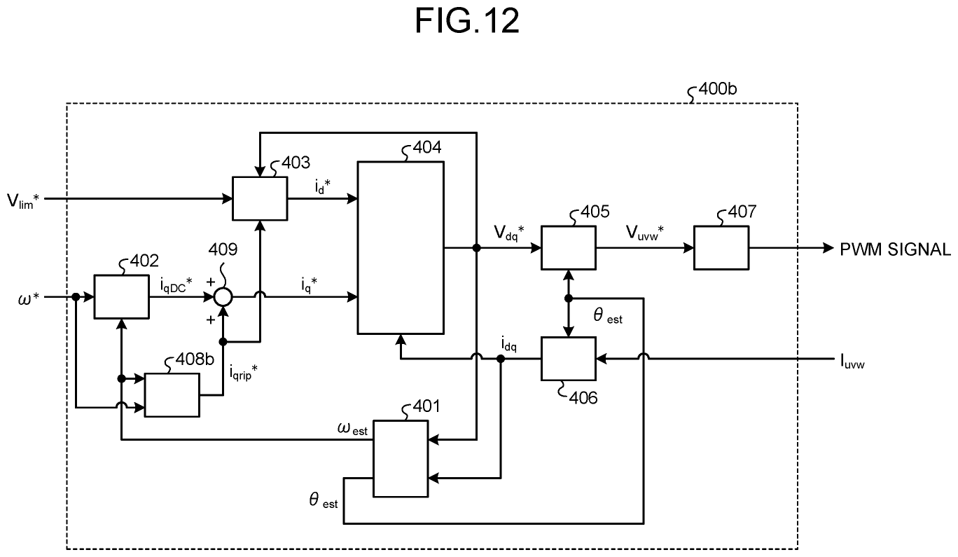

FIG. 12 is a block diagram illustrating an example configuration of a control unit of the power converting apparatus according to a fourth embodiment.

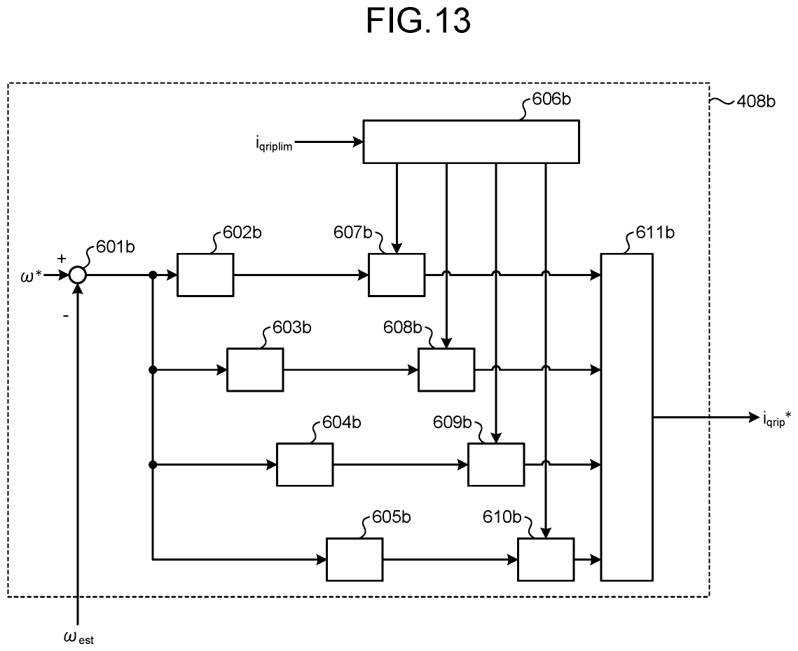

FIG. 13 is a block diagram illustrating an example configuration of a q-axis current pulsation computing unit of the control unit of the power converting apparatus according to the fourth embodiment.

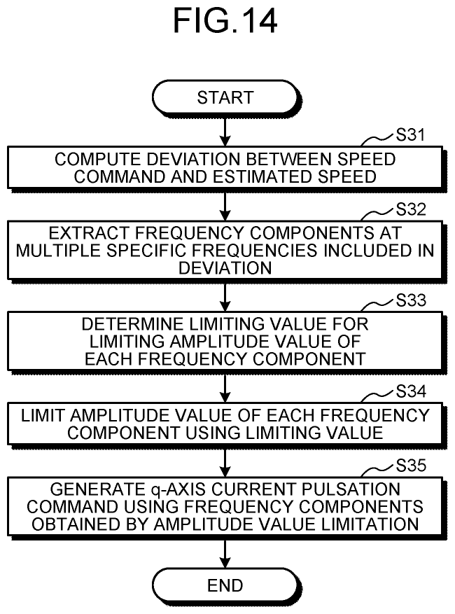

FIG. 14 is a flowchart illustrating an operation of the q-axis current pulsation computing unit of the control unit of the power converting apparatus according to the fourth embodiment.

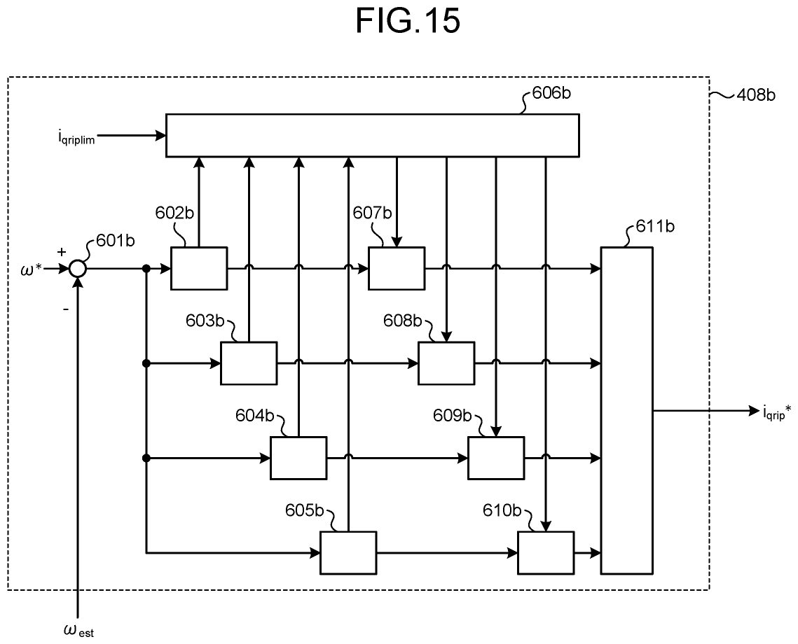

FIG. 15 is a first block diagram illustrating an example configuration of the q-axis current pulsation computing unit of the control unit of the power converting apparatus according to a fifth embodiment.

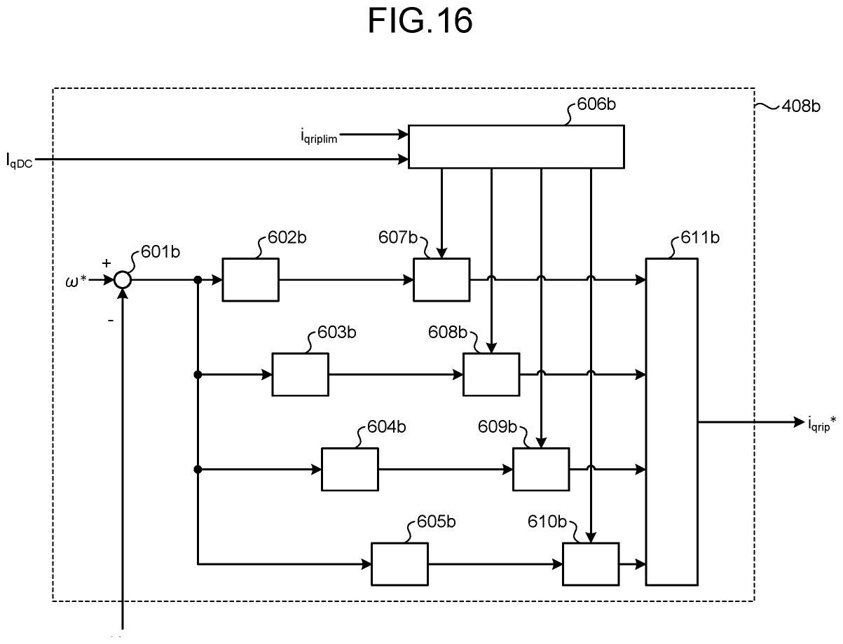

FIG. 16 is a second block diagram illustrating an example configuration of the q-axis current pulsation computing unit of the control unit of the power converting apparatus according to the fifth embodiment.

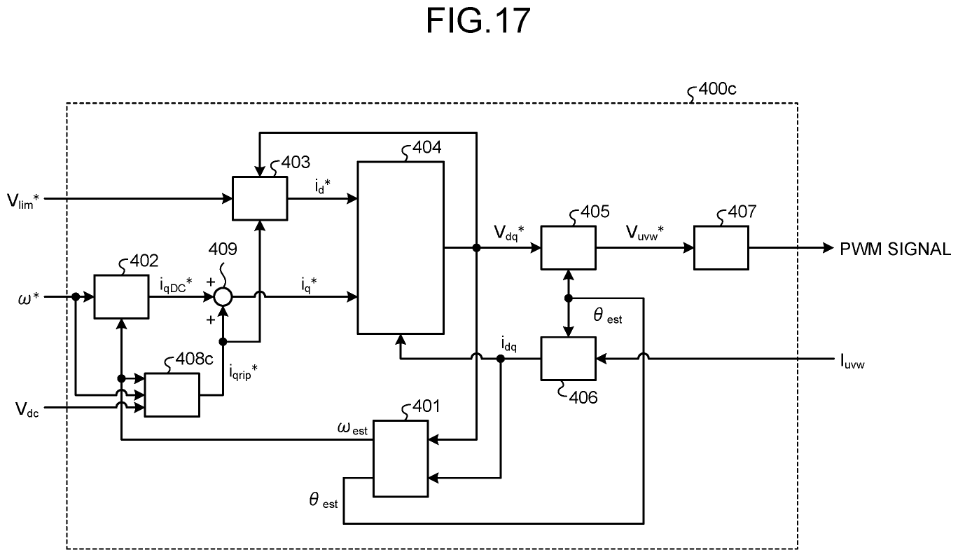

FIG. 17 is a block diagram illustrating an example configuration of a control unit of the power converting apparatus according to a sixth embodiment.

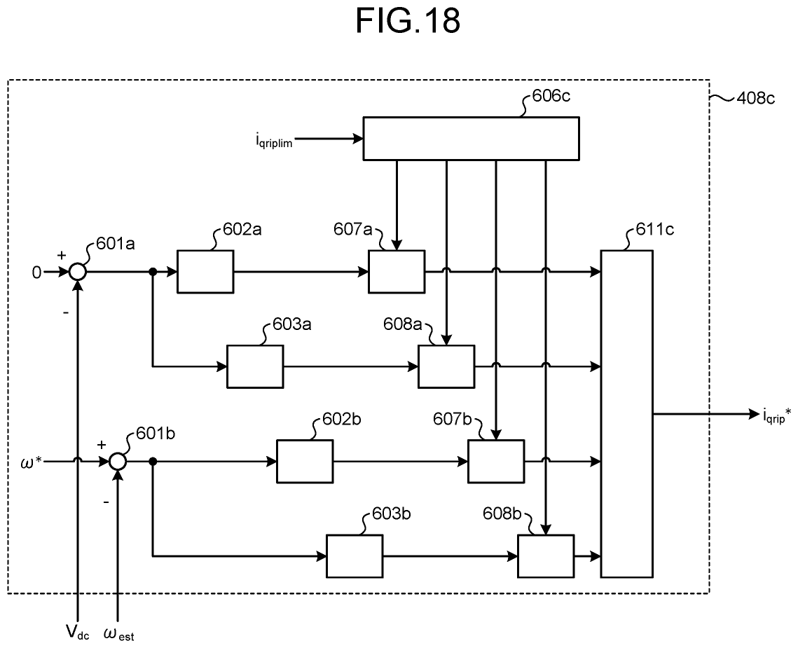

FIG. 18 is a first block diagram illustrating an example configuration of a q-axis current pulsation computing unit of the control unit of the power converting apparatus according to the sixth embodiment.

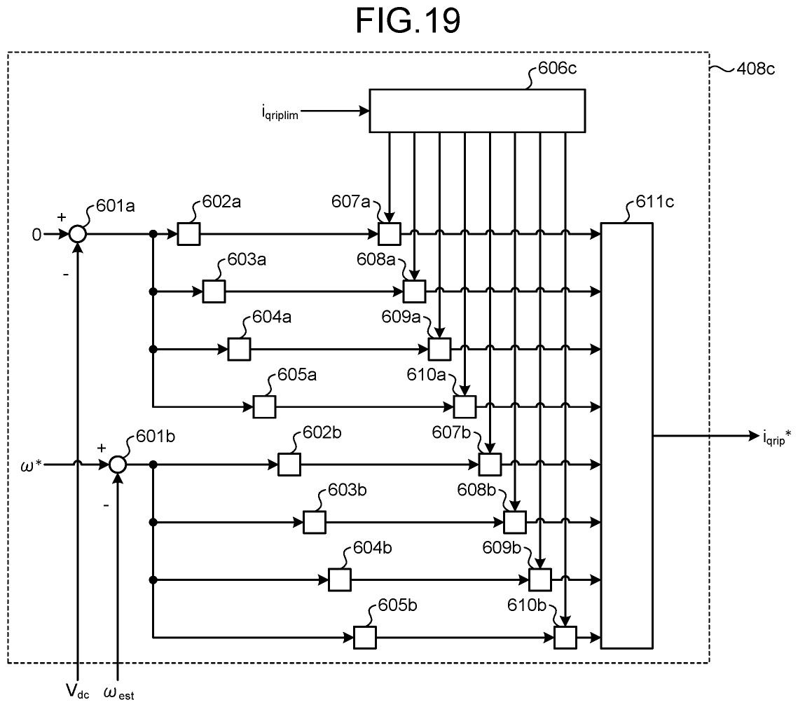

FIG. 19 is a second block diagram illustrating an example configuration of the q-axis current pulsation computing unit of the control unit of the power converting apparatus according to the sixth embodiment.

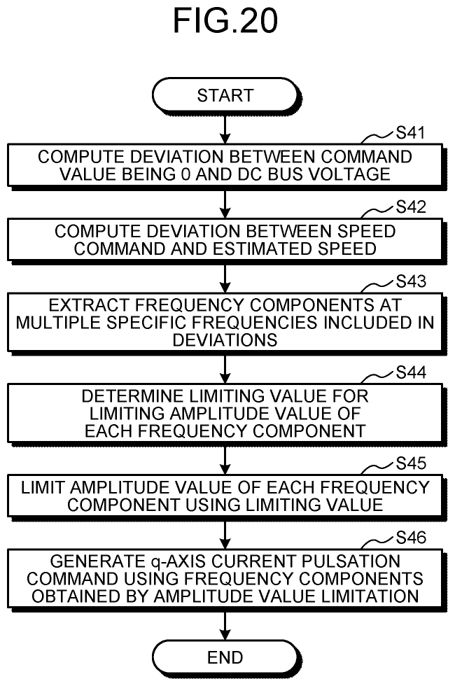

FIG. 20 is a flowchart illustrating an operation of the q-axis current pulsation computing unit of the control unit of the power converting apparatus according to the sixth embodiment.

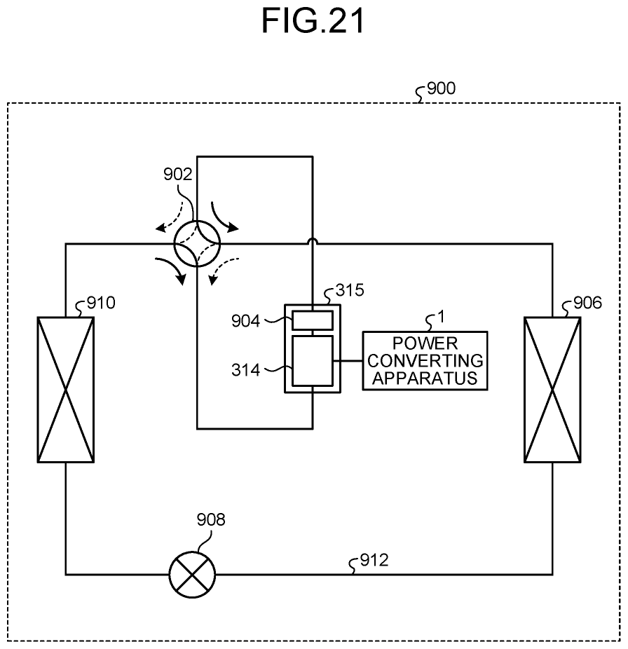

FIG. 21 is a diagram illustrating an example configuration of a refrigeration cycle-incorporating apparatus according to a seventh embodiment.

### DESCRIPTION OF EMBODIMENTS

A power converting apparatus, a motor drive unit, and a refrigeration cycle-incorporating apparatus according to embodiments of the present disclosure will be described in detail below with reference to the drawings.

### First Embodiment

FIG. 1 is a diagram illustrating an example configuration of a power converting apparatus 1 according to a first embodiment. The power converting apparatus 1 is connected to a commercial power supply 110 and a compressor 315. The power converting apparatus 1 converts first alternating-current (AC) power into second AC power, and supplies the second AC power to the compressor 315. The first alternating-current (AC) power has a supply voltage Vs supplied from the commercial power supply 110. The second AC power has a desired amplitude and phase. The power converting apparatus 1 includes a reactor 120, a rectifier unit 130, a voltage detection unit 501, a smoothing unit 200, an inverter 310, current detection units 313a and 313b, and a control unit 400. Note that the power converting apparatus 1 and a motor 314 of the compressor 315 form a motor drive unit 2.

The reactor 120 is connected between the commercial power supply 110 and the rectifier unit 130. The rectifier unit 130 includes a bridge circuit including rectifier elements 131 to 134 to rectify the first AC power having the supply voltage Vs supplied from the commercial power supply 110, and outputs the thus rectified power. The rectifier unit 130 provides full-wave rectification. The voltage detection unit 501 detects a direct-current (DC) bus voltage V_{dc}. The direct-current (DC) bus voltage V_{dc} is the voltage across the smoothing unit 200 charged with current flowing from the rectifier unit 130 into the smoothing unit 200 after being rectified by the rectifier unit 130. The voltage detection unit 501 outputs the detected voltage value to the control unit 400. The voltage detection unit 501 is a detection unit that detects a power state of the capacitor 210.

The smoothing unit 200 is connected to output ends of the rectifier unit 130. The smoothing unit 200 includes the capacitor 210 as a smoothing element to smooth the power rectified by the rectifier unit 130. The capacitor 210 is, for example, an electrolytic capacitor, a film capacitor, or the like. The capacitor 210 is connected to the output ends of the rectifier unit 130. The capacitor 210 has a capacity sufficient for smoothing the power rectified by the rectifier unit 130. The voltage across the capacitor 210 obtained by smoothing does not have a full-wave rectified waveform of the commercial power supply 110, but has a waveform including a voltage ripple superimposed on a DC component, which voltage ripple is dependent on the frequency of the commercial power supply 110. The foregoing voltage across the capacitor 210 thus does not pulsate largely. This voltage ripple has a frequency twice the frequency of the supply voltage Vs when the commercial power supply 110 is a single-phase power supply, and has a main component at a frequency six times the frequency of the supply voltage Vs when the commercial power supply 110 is a three-phase power supply. When neither the power input from the commercial power supply 110 nor the power output from the inverter 310 varies, the amplitude of this voltage ripple depends on the capacity of the capacitor 210. For example, the voltage ripple occurring on the capacitor 210 pulsates within a range having a maximum value less than twice the minimum value.

The inverter 310 is connected across the smoothing unit 200, that is, connected across the capacitor 210. The inverter 310 includes switching elements 311a to 311f and freewheeling diodes 312a to 312f. The inverter 310 turns on and off the switching elements 311a to 311f under the control of the control unit 400 to convert the power output from the rectifier unit 130 and the smoothing unit 200 into second AC power having a desired amplitude and phase, i.e., to generate the second AC power, and outputs the second AC power to the compressor 315. The current detection units 313a and 313b each detect a current value of a corresponding one of three phases of the current output from the inverter 310, and each output the detected current value to the control unit 400. Note that by obtaining current values of two phases among current values of the three phases output from the inverter 310, the control unit 400 can calculate the current value of the remaining one phase output from the inverter 310. The compressor 315 is a load including the motor 314 for driving the compressor. The motor 314 rotates depending on the amplitude and the phase of the second AC power supplied from the inverter 310 to thus perform compression operation. For example, when the compressor 315 is a hermetic-type compressor for use in an air conditioner or the like, the load torque of the compressor 315 can often be regarded as constant torque load. Although FIG. 1 illustrates the motor 314 as having a motor winding of Y connection, by way of example, and the connection topology is not limited thereto. The motor 314 may have a motor winding of delta (Δ) connection, or may have a motor winding designed to be switchable between Y connection and Δ connection.

Note that the arrangement of the components of the power converting apparatus 1 illustrated in FIG. 1 is merely one example, and the arrangement of the components is not limited to this example illustrated in FIG. 1. For example, the reactor 120 may be disposed downstream of the rectifier unit 130. In addition, the power converting apparatus 1 may include a booster unit, or the rectifier unit 130 may be designed to have functionality of a booster unit. The voltage detection unit 501 and the current detection units 313a and 313b may each be referred to hereinafter collectively as detection unit. In addition, the voltage value detected by the voltage detection unit 501 and the current values detected by the current detection units 313a and 313b may each be referred to hereinafter as detection value.

The control unit 400 obtains the voltage value of the DC bus voltage V_{dc} of the smoothing unit 200 from the voltage detection unit 501, and obtains, from each of the current detection units 313a and 313b, the current value of the second AC power having a desired amplitude and phase obtained by conversion performed by the inverter 310. The control unit 400 controls the operation of the inverter 310, specifically, turning on and off of the switching elements 311a to 311f of the inverter 310, using the detection values detected by the individual detection units. The control unit 400 also controls the operation of the motor 314, using the detection values detected by the individual detection units. In the present embodiment, the control unit 400 controls the operation of the inverter 310 such that the inverter 310 outputs, to the compressor 315, i.e., a load, the second AC power including a pulsation dependent on the pulsation of the power flowing from the rectifier unit 130 into the capacitor 210 of the smoothing unit 200. The phrase “pulsation dependent on the pulsation of the power flowing into the capacitor 210 of the smoothing unit 200” refers to, for example, a pulsation that fluctuates according to, for example, the frequency of the pulsation of the power flowing into the capacitor 210 of the smoothing unit 200. Through such control, the control unit 400 reduces the amount of current flowing into the capacitor 210 of the smoothing unit 200. The control unit 400 does not necessarily need to use all the detection values obtained from the individual detection units, and may perform control using one or some of the detection values.

The control unit 400 provides control that brings any of the speed, the voltage, and the current of the motor 314 to a desired condition. The motor 314 is used for driving the compressor 315 that is a hermetic-type compressor, in which case the structure and cost of a position sensor for detecting the rotor position makes it difficult to attach the position sensor to the motor 314. For this reason, the control unit 400 performs position sensorless control on the motor 314. There are two types of methods of position sensorless control on the motor 314: constant primary magnetic flux control; and sensorless vector control. The present embodiment will be described, by way of example, on the basis of sensorless vector control. Note that the control method described below is also applicable to constant primary magnetic flux control with minor modification. In the present embodiment, the control unit 400 controls the operations of the inverter 310 and the motor 314, using a dq-rotational coordinate system that rotates in synchronization with the rotor position of the motor 314 as described later.

A description will be made as to a specific operation of the control unit 400 in the present embodiment. As illustrated in FIG. 1, currents in the power converting apparatus 1 are designated as follows: the input current from the rectifier unit 130 to the capacitor 210 of the smoothing unit 200 is designated as input current I1, the output current from the capacitor 210 of the smoothing unit 200 to the inverter 310 is designated as output current I2, and a charge-discharge current of the capacitor 210 of the smoothing unit 200 is designated as charge-discharge current I3. Although the input current I1 is affected by factors such as the power supply phase of the commercial power supply 110, and the characteristic of each of elements disposed upstream and downstream of the rectifier unit 130, the input current I1 basically has characteristics including a component having a frequency 2n times the power supply frequency, where n is an integer greater than or equal to 1.

When an electrolytic capacitor is used as the capacitor 210 of the smoothing unit 200, the charge-discharge current I3 having a large value will accelerate aging degradation of the capacitor 210. To reduce the charge-discharge current I3 and the aging degradation of the capacitor 210, the control unit 400 is required to control the inverter 310 such that the input current I1 to the capacitor 210 becomes equal to the output current I2 from the capacitor 210. As a ripple component caused by pulse width modulation (PWM) is superposed on the output current I2, the control unit 400 needs to control the inverter 310, taking that ripple component into consideration. To reduce the degradation of the capacitor 210, the control unit 400 is required to decrease the charge-discharge current I3 by monitoring the power states of the smoothing unit 200, i.e., the power state of the capacitor 210 and providing the motor 314 with an appropriate pulsation. In this respect, the power states of the capacitor 210 include, for example, the input current I1 to the capacitor 210, the output current I2 from the capacitor 210, the charge-discharge current I3 of the capacitor 210, and the DC bus voltage V_{dc} of the capacitor 210. For degradation reducing control, the control unit 400 requires at least one piece of information among these power states of the capacitor 210.

In the present embodiment, using the DC bus voltage V_{dc} of the capacitor 210 detected by the voltage detection unit 501, the control unit 400 provides the motor 314 with a pulsation such that the value of the output current I2 having the PWM ripple removed matches the value of the input current I1. That is, the control unit 400 controls the operation of the inverter 310 such that a pulsation dependent on the detection value from the voltage detection unit 501 is superimposed on a drive pattern of the motor 314, thus reducing the charge-discharge current I3 of the capacitor 210. A relationship between input power and output power to and from the motor 314 allows the control unit 400 to control a q-axis current command i_{q}* for the motor 314 so as to reduce a difference between the input current I1 and the output current I2. In the case of this control method, the control unit 400 uses a relationship between the input power to the inverter 310 and a mechanical output from the motor 314 in calculating an ideal q-axis current command i_{q}* for reducing the charge-discharge current I3. Thus, in the present embodiment, the control unit 400 performs control in a rotational coordinate system having a d-axis and a q-axis. Note that although the power converting apparatus 1 is capable of estimating the charge-discharge current I3 of the capacitor 210 from the DC bus voltage V_{dc} of the capacitor 210, the power converting apparatus 1 may include a current detection unit for detecting the charge-discharge current I3 of the capacitor 210.

In the power converting apparatus 1, the voltage detection unit 501 detects the voltage value of the DC bus voltage V_{dc} of the capacitor 210, and outputs the voltage value to the control unit 400. The control unit 400 controls the inverter 310 such that the value of the output current I2 flowing from the capacitor 210 to the inverter 310 minus the PWM ripple matches the value of the input current I1, and the control unit 400 provides a pulsation for the power output to the motor 314. The control unit 400 can reduce the charge-discharge current I3 of the capacitor 210 by causing the output current I2 to pulsate appropriately. As described above, the input current I1 to the capacitor 210 includes a component having a frequency that is 2n times the power supply frequency, and therefore, the output current I2 and a q-axis current i_{q} of the motor 314 also include a component having a frequency that is 2n times the power supply frequency. Note that, in addition to the capacitor current reducing control as described above, the control unit 400 is capable of controlling the q-axis current command i_{q}* so as to reduce pulsations occurring on the rotational speed of the motor 314, the DC bus voltage V_{dc}, the current flowing to the motor 314, etc. Alternatively, the control unit 400 is also capable of performing these controls in parallel.

A configuration and an operation of the control unit 400 will next be described. FIG. 2 is a block diagram illustrating an example configuration of the control unit 400 of the power converting apparatus 1 according to the first embodiment. The control unit 400 includes a rotor position estimation unit 401, a speed control unit 402, a flux-weakening control unit 403, a current control unit 404, coordinate conversion units 405 and 406, a PWM signal generation unit 407, a q-axis current pulsation computing unit 408, and an addition unit 409.

The rotor position estimation unit 401 estimates an estimated phase angle θₑₛₜ and an estimated speed West of a rotor (not illustrated) of the motor 314, on the basis of a dq-axis current vector i_{dq} and a dq-axis voltage command vector V_{dq}* for the motor 314. The estimated phase angle θest is the direction of the rotor magnetic pole with respect to dq axes, and the estimated speed West is the rotor speed.

The speed control unit 402 generates a q-axis current command i_{qDC}* from a speed command ω* and the estimated speed West. Specifically, the speed control unit 402 automatically adjusts the q-axis current command i_{qDC}* such that the speed command ω* matches the estimated speed ωₑₛₜ. When the power converting apparatus 1 is used as a refrigeration cycle-incorporating apparatus in an air conditioner or the like, the speed command ω* is based on, for example, a temperature detected by a temperature sensor (not illustrated), information representing a setting temperature indicated by a remote controller (not illustrated) serving as an operation unit, operation mode selection information, information on instructions for the start of operation and the termination of operation, and the like. Examples of the operation mode include heating, cooling, and dehumidification. The q-axis current command i_{qDC}* may be referred to hereinafter as first q-axis current command.

The flux-weakening control unit 403 automatically adjusts a d-axis current command i_{d}* such that the absolute value of the dq-axis voltage command vector V_{dq}* falls within a limitation value of a voltage limit value Vₗᵢₘ* In addition, in the present embodiment, the flux-weakening control unit 403 performs flux-weakening control, taking into consideration a q-axis current pulsation command i_{qrip}* computed by the q-axis current pulsation computing unit 408. There are roughly two types of flux-weakening control: a method in which to calculate the d-axis current command i_{d}* from a voltage limit ellipse equation; and a method in which to calculate the d-axis current command i_{d}* such that a difference in absolute value between the voltage limit value Vₗᵢₘ* and the dq-axis voltage command vector V_{dq}* becomes zero. Either of these methods may be used.

The current control unit 404 controls the current flowing to the motor 314, using the q-axis current command i_{q}* and the d-axis current command i_{d}*, and generates the dq-axis voltage command vector V_{dq}*. Specifically, the current control unit 404 automatically adjusts the dq-axis voltage command vector V_{dq}* such that the dq-axis current vector i_{d}, follows the d-axis current command i_{d}* and the q-axis current command i_{q}*. The dq-axis voltage command vector V_{dq}* may be referred to hereinafter simply as dq-axis voltage command.

The coordinate conversion unit 405 performs coordinate transformation to convert the dq-axis voltage command vector V_{dq}* represented by dq coordinates, into a voltage command V_{uvw}* in AC amounts, in accordance with the estimated phase angle θₑₛₜ.

The coordinate conversion unit 406 performs coordinate transformation to convert a current I_{uvw} in AC amounts flowing to the motor 314, into the dq-axis current vector i_{dq} represented by dq coordinates, in accordance with the estimated phase angle θₑₛₜ. As described above, the current values of two phases among the current values of the three phases output from the inverter 310 are detected by the current detection units 313a and 313b, and the control unit 400 calculates the current value of the remaining one phase, using the current values of the two phases. From the detected current values and the calculated current value, the control unit 400 can obtain the current I_{uvw} flowing to the motor 314.

The PWM signal generation unit 407 generates a PWM signal on the basis of the voltage command V_{uvw}* obtained by coordinate transformation performed by the coordinate conversion unit 405. The control unit 400 applies a voltage to the motor 314 by outputting, to the switching elements 311a to 311f of the inverter 310, the PWM signal generated by the PWM signal generation unit 407.

The q-axis current pulsation computing unit 408 computes a q-axis current pulsation i_{qrip} in accordance with some pulsatile component xᵣᵢₚ occurring depending on the operation of the power converting apparatus 1 and generates the foregoing q-axis current pulsation command i_{qrip}* that is the pulsatile component of the q-axis current command i_{q}*. As the pulsation amplitude of the q-axis current i_{q} varies depending on the condition of driving the motor 314, the q-axis current pulsation computing unit 408 appropriately takes the drive condition into consideration in determining the amplitude, using proportional integral differential (PID) control etc. A detailed configuration and operation of the q-axis current pulsation computing unit 408 will be described later.

The addition unit 409 generates the q-axis current command i_{q}* by adding together the q-axis current command i_{qDC}* output from the speed control unit 402 and the q-axis current pulsation command i_{qrip}* computed by the q-axis current pulsation computing unit 408, and outputs the q-axis current command i_{q}* to the current control unit 404. The q-axis current command i_{q}* may be referred to hereinafter as second q-axis current command.

A configuration and an operation of the q-axis current pulsation computing unit 408 will next be described. FIG. 3 is a block diagram illustrating an example configuration of the q-axis current pulsation computing unit 408 of the control unit 400 of the power converting apparatus 1 according to the first embodiment. The q-axis current pulsation computing unit 408 includes a subtraction unit 601, Fourier coefficient computing units 602 to 605, an amplitude control unit 606, PID control units 607 to 610, and an AC restoration unit 611. The q-axis current pulsation computing unit 408 is configured as a feedback controller that uses a command value of zero. A feedback controller, which is generally slower in control response than a feedforward controller, is unsuitable for reducing a high frequency pulsation. Nevertheless, various means for reducing a high frequency pulsation have heretofore been proposed, and are well known. One widely-known method is a technique using Fourier coefficient calculation and PID control.

The subtraction unit 601 computes a deviation between the command value “0” and the pulsatile component xᵣᵢₚ that is an input signal.

The Fourier coefficient computing units 602 to 605 uses the theory of Fourier series expansion to thereby extract amplitudes of sine signal components and cosine signal components at specific frequencies included in the deviation computed by the subtraction unit 601. In the present embodiment, the Fourier coefficient computing units 602 to 605 compute amplitudes of a sin 1f component, a cos 1f component, a sin 2f component, and a cos 2f component included in the foregoing deviation, where 1f represents a specified frequency included in the foregoing deviation. The Fourier coefficient computing units 602 to 605 each multiply the deviation by a corresponding one of detection signals having values of sin 1ωᵢₙₜ, cos 1ωᵢₙₜ, sin 2ωᵢₙₜ, and cos 2ωᵢₙₜ. Each value twice the average value of the product of the deviation, i.e., an input signal, and the corresponding one of the detection signals represents the corresponding one of the amplitude values of the sin 1f component, the cos 1f component, the sin 2f component, and the cos 2f component included in the deviation. For example, the Fourier coefficient computing unit 602 multiplies the deviation by a detection signal of sin 1ωᵢₙₜ, and computes the amplitude value of the sin 1f component of the pulsation included in the pulsatile component xᵣᵢₚ. The Fourier coefficient computing unit 603 multiplies the deviation by a detection signal of cos 1ωᵢₙₜ, and computes the amplitude value of the cos 1f component of the pulsation included in the pulsatile component xᵣᵢₚ. The Fourier coefficient computing unit 604 multiplies the deviation by a detection signal of sin 2ωᵢₙₜ, and computes the amplitude value of the sin 2f component of the pulsation included in the pulsatile component xᵣᵢₚ. The Fourier coefficient computing unit 605 multiplies the deviation by a detection signal of cos 2ωᵢₙₜ, and computes the amplitude value of the cos 2f component of the pulsation included in the pulsatile component xᵣᵢₚ.

The PID control units 607 to 610 each perform proportional integral differential control, i.e., PID control, to bring to zero the specific frequency component of the deviation extracted by the corresponding one of the Fourier coefficient computing units 602 to 605. As illustrated in FIG. 3, the PID control unit 607 is connected to the Fourier coefficient computing unit 602, the PID control unit 608 is connected to the Fourier coefficient computing unit 603, the PID control unit 609 is connected to the Fourier coefficient computing unit 604, and the PID control unit 610 is connected to the Fourier coefficient computing unit 605. In this configuration, the proportional gain and the differential gain can be zero, but the integral gain needs to have a value of non-zero in order to allow the deviation to converge to zero. The PID control units 607 to 610 therefore primarily perform integral operation. As the output of integral control typically gently changes, the output from each of the PID control units 607 to 610 can also be regarded as almost constant.

To restore an AC value from the outputs from the PID control units 607 to 610, the AC restoration unit 611 multiplies each of the outputs from the PID control units 607 to 610 by a corresponding one of sin 1ωᵢₙₜ, cos 1ωᵢₙₜ, sin 2ωᵢₙₜ, and cos 2ωᵢₙₜ, and calculates a sum of the resulting products to thus generate the q-axis current pulsation command i_{qrip}*.

For example, a large amplitude of the q-axis current pulsation command i_{qrip}* or an insufficient margin between a DC component i_{qDC} of the q-axis current command i_{q}*and a limit value i_{qlim} of the q-axis current command i_{q}*may result in exceeding the permissible current value of the inverter 310. In such a case, typically, a limiter for the q-axis current pulsation command i_{qrip}* is inserted downstream of the stage configured to generate the q-axis current pulsation command i_{qrip}*, such that the q-axis current command i_{q}*should not become excessively large. However, such method suffers from a problem. Specifically, as the q-axis current pulsation command i_{qrip}* is limited by a limit value i_{qriplim} of the q-axis current pulsation command i_{qrip}*, the q-axis current pulsation command i_{qrip} has a small amplitude, thereby reducing the effect that would otherwise be provided by the stage configured to generate the q-axis current pulsation command i_{qrip}*. Such method, which limits the q-axis current pulsation command i_{qrip}* by the limit value i_{qriplim} of the q-axis current pulsation command i_{qrip}*, results in the decrease in the amplitude value of each of the frequency components included in the q-axis current pulsation command i_{qrip}*. In other words, the amplitude value of each of the frequency components will not be determined of its own accord.

In the present embodiment, the amplitude control unit 606 adjusts, on a per frequency component basis, the amplitude values of multiple frequency components included in the q-axis current pulsation command i_{qrip}* to thereby improve the effect of the q-axis current pulsation computing unit 408. For example, in accordance with the limit value i_{qriplim} of the q-axis current pulsation command i_{qrip}*, the amplitude control unit 606 may assign the PID control units 607 to 610 with specific amplitude values of the individual frequency components, or with ratios for reducing the amplitude values of the individual frequency components extracted by the Fourier coefficient computing units 602 to 605. The amplitude control unit 606 may assign limiting values to the PID control units 607 to 610 to reduce the amplitude values of the individual frequency components extracted by the Fourier coefficient computing units 602 to 605, or may assign gains to the PID control units 607 to 610 to reduce the amplitude values of the individual frequency components extracted by the Fourier coefficient computing units 602 to 605. The amplitude control unit 606 may store in advance the limit value i_{qriplim} of the q-axis current pulsation command i_{qrip}*. Alternatively, the amplitude control unit 606 may obtain the q-axis current command i_{qDC}* generated by the speed control unit 402, and then obtain, by computation, the limit value i_{qriplim} of the q-axis current pulsation command i_{qrip}*, using the q-axis current command i_{qDC}*.

Although the q-axis current pulsation computing unit 408 in the present embodiment includes, by way of example, the four Fourier coefficient computing units 602 to 605 and the four PID control units 607 to 610, the q-axis current pulsation computing unit 408 is not limited thereto. The q-axis current pulsation computing unit 408 may include six Fourier coefficient computing units and six PID control units, or may include eight or more Fourier coefficient computing units and eight or more PID control units. For example, when the q-axis current pulsation computing unit 408 includes six Fourier coefficient computing units and six PID control units, the q-axis current pulsation computing unit 408 performs control of a sin 3f component and a cos 3f component in addition to the foregoing four frequency components. Alternatively, when the q-axis current pulsation computing unit 408 includes eight Fourier coefficient computing units and eight PID control units, the q-axis current pulsation computing unit 408 performs control of the sin 3f component, the cos 3f component, a sin 4f component, and a cos 4f component in addition to the foregoing four frequency components.

As described above, the q-axis current pulsation computing unit 408 of the control unit 400 extracts multiple frequency components from the q-axis current pulsation i_{qrip}, the q-axis current pulsation i_{qrip} being the pulsatile component of the q-axis current i_{q}, and limits the amplitude value of each of the extracted frequency components to thus control the amplitude of the q-axis current pulsation i_{qrip}.

FIG. 4 is a flowchart illustrating an operation of the q-axis current pulsation computing unit 408 of the control unit 400 of the power converting apparatus 1 according to the first embodiment. In the q-axis current pulsation computing unit 408, the subtraction unit 601 computes a deviation between the command value “0” and the pulsatile component xᵣᵢₚ (step S11). The Fourier coefficient computing units 602 to 605 extract frequency components at multiple specific frequencies included in the deviation computed by the subtraction unit 601 (step S12). The amplitude control unit 606 determines a limiting value for limiting the amplitude value of each of the frequency components (step S13). The PID control units 607 to 610 each limit the amplitude value of a corresponding one of the frequency components extracted by the Fourier coefficient computing units 602 to 605, using the limiting value determined by the amplitude control unit 606 (step S14). The AC restoration unit 611 generates the q-axis current pulsation command i_{qrip}*, using the frequency components obtained by amplitude value limiting operation performed by the PID control units 607 to 610 (step S15).

A hardware configuration of the control unit 400 included in the power converting apparatus 1 will next be described. FIG. 5 is a diagram illustrating an example of hardware configuration for implementing the control unit 400 included in the power converting apparatus 1 according to the first embodiment. The control unit 400 is implemented by a combination of a processor 91 and a memory 92.

The processor 91 is a central processing unit (CPU) (also known as a processing unit, a computing unit, a microprocessor, a microcomputer, a processor, and a digital signal processor (DSP)) or a system large scale integration (LSI). The memory 92 may be, for example, a non-volatile or volatile semiconductor memory such as a random access memory (RAM), a read-only memory (ROM), a flash memory, an erasable programmable read-only memory (EPROM), or an electrically erasable programmable read-only memory (EEPROM) (registered trademark). In addition, the memory 92 is not limited to these, and may also be a magnetic disk, an optical disk, a compact disc, a MiniDisc, or a digital versatile disc (DVD).

As described above, according to the present embodiment, the q-axis current pulsation computing unit 408 of the control unit 400 of the power converting apparatus 1 performs control that limits the amplitudes for a fundamental frequency and a frequency that is a positive integer multiple of the fundamental frequency, of the pulsatile components included in some pulsatile component xᵣᵢₚ occurring depending on the operation of the power converting apparatus 1. This enables the control unit 400 of the power converting apparatus 1 to increase accuracy of compensation in compensation control of causing a q-axis current i_{q} to pulsate. Accordingly, the power converting apparatus 1 can provide an advantage such as copper loss reduction.

### Second Embodiment

A second embodiment will be specifically described as to the capacitor current reducing control when the pulsatile component xᵣᵢₚ is the DC bus voltage V_{dc} detected by the voltage detection unit 501. Note that although the second embodiment will be described with reference to the DC bus voltage Vas detected by the voltage detection unit 501, the charge-discharge current I3 of the capacitor 210 may be used instead of the DC bus voltage V_{dc} when the power converting apparatus 1 includes a current detection unit that detects the charge-discharge current I3 of the capacitor 210 as the power state of the capacitor 210.

FIG. 6 is a block diagram illustrating an example configuration of a control unit 400a of the power converting apparatus 1 according to the second embodiment. The control unit 400a includes a q-axis current pulsation computing unit 408a in place of the q-axis current pulsation computing unit 408 of the control unit 400 of the first embodiment illustrated in FIG. 2. Note that although not illustrated, the power converting apparatus 1 according to the second embodiment includes the control unit 400a in place of the control unit 400 of the power converting apparatus 1 of the first embodiment illustrated in FIG. 1.

FIG. 7 is a block diagram illustrating an example configuration of the q-axis current pulsation computing unit 408a of the control unit 400a of the power converting apparatus 1 according to the second embodiment. The q-axis current pulsation computing unit 408a includes a subtraction unit 601a, Fourier coefficient computing units 602a to 605a, an amplitude control unit 606a, PID control units 607a to 610a, and an AC restoration unit 611a.

The subtraction unit 601a functions similarly to the subtraction unit 601. The subtraction unit 601a computes a deviation between the command value “0” and the DC bus voltage V_{dc} that is the detection value detected by the voltage detection unit 501 for detecting the power state of the capacitor 210. The value “0” may be hereinafter described as “zero”.

The Fourier coefficient computing units 602a to 605a function similarly to the Fourier coefficient computing units 602 to 605. In the present embodiment, the Fourier coefficient computing units 602a to 605a compute amplitudes of the sin 2f component, the cos 2f component, the sin 4f component, and the cos 4f component included in the deviation computed by the subtraction unit 601a, where 1f represents the power supply frequency of the first AC power supplied from the commercial power supply 110. Note that the value “f” in the second embodiment may be different from or equal to the value “f” in the first embodiment. The Fourier coefficient computing units 602a to 605a each multiply the deviation by a corresponding one of detection signals having values of sin 2ωᵢₙₜ, cos 2ωᵢₙₜ, sin 4ωᵢₙₜ, and cos 4ωᵢₙₜ. Each value twice the average value of the product of the deviation, i.e., an input signal, and the corresponding one of the detection signals represents the corresponding one of the amplitude values of the sin 2f component, the cos 2f component, the sin 4f component, and the cos 4f component included in the deviation. For example, the Fourier coefficient computing unit 602a multiplies the deviation by a detection signal of sin 2ωᵢₙₜ, and computes the amplitude value of the sin 2f component of the pulsation included in the DC bus voltage V_{dc}. The Fourier coefficient computing unit 603a multiplies the deviation by a detection signal of cos 2ωᵢₙₜ, and computes the amplitude value of the cos 2f component of the pulsation included in the DC bus voltage V_{dc}. The Fourier coefficient computing unit 604a multiplies the deviation by a detection signal of sin 4ωᵢₙₜ, and computes the amplitude value of the sin 4f component of the pulsation included in the DC bus voltage V_{dc}. The Fourier coefficient computing unit 605a multiplies the deviation by a detection signal of cos 4ωᵢₙₜ, and computes the amplitude value of the cos 4f component of the pulsation included in the DC bus voltage V_{dc}. Note that when the charge-discharge current I3 of the capacitor 210 is in a periodic waveform, the Fourier coefficient computing units 602a to 605a each output an almost constant signal. As described above, the Fourier coefficient computing units 602a to 605a, which are multiple Fourier coefficient computing units, each extract, from the deviation computed by the subtraction unit 601a, a corresponding one of a sine component of a first frequency, a cosine component of the first frequency, a sine component of a second frequency, and a cosine component of the second frequency, where the first frequency is twice the frequency of the first AC power, and the second frequency equaling the first frequency multiplied by an integer greater than or equal to 2. In the second embodiment, the first frequency is 2f, and the second frequency is 4f.

The amplitude control unit 606a functions similarly to the amplitude control unit 606. In accordance with the limit value i_{qriplim} of the q-axis current pulsation command i_{qrip}*, the amplitude control unit 606a may assign the PID control units 607a to 610a with specific amplitude values of the individual frequency components, or ratios for reducing the amplitude values of the individual frequency components extracted by the Fourier coefficient computing units 602a to 605a. The amplitude control unit 606a may store in advance the limit value i_{qriplim} of the q-axis current pulsation command i_{qrip}*. Alternatively, the amplitude control unit 606a may obtain the q-axis current command i_{qDC}* generated by the speed control unit 402, and then obtain, by computation, the limit value i_{qriplim} of the q-axis current pulsation command i_{qrip}*, using the q-axis current command i_{qDC}*. As described above, the amplitude control unit 606a determines a limiting value for limiting the amplitude value of each of the frequency components extracted by the Fourier coefficient computing units 602a to 605a.

The PID control units 607a to 610a function similarly to the PID control units 607 to 610. The PID control units 607a to 610a perform proportional integral differential control, i.e., PID control, to bring to zero the specific frequency component of the deviation extracted by the corresponding one of the Fourier coefficient computing units 602a to 605a. As illustrated in FIG. 7, the PID control unit 607a is connected to the Fourier coefficient computing unit 602a, the PID control unit 608a is connected to the Fourier coefficient computing unit 603a, the PID control unit 609a is connected to the Fourier coefficient computing unit 604a, and the PID control unit 610a is connected to the Fourier coefficient computing unit 605a. As discussed above, the PID control units 607a to 610a, which are multiple integral control units, are each connected to a corresponding one of the Fourier coefficient computing units 602a to 605a, and each limit the amplitude value of the frequency component extracted by the Fourier coefficient computing unit connected thereto, using the limiting value determined by the amplitude control unit 606a.

The AC restoration unit 611a functions similarly to the AC restoration unit 611. To restore an AC value from the outputs from the PID control units 607a to 610a, the AC restoration unit 611a multiplies each of the outputs from the PID control units 607a to 610a by a corresponding one of sin 2ωᵢₙₜ, cos 2ωᵢₙₜ, sin 4ωᵢₙₜ, and cos 4ωᵢₙₜ, and calculates a sum of the resulting products to thus generate the q-axis current pulsation command i_{qrip}*. As described above, the AC restoration unit 611a generates a signal having an AC component, using the individual frequency components obtained by amplitude value limiting operation performed by the PID control units 607a to 610a, and outputs the signal having the AC component as the q-axis current pulsation command i_{qrip}* for controlling the amplitude of the q-axis current pulsation i_{qrip}.

Although the q-axis current pulsation computing unit 408a in the present embodiment includes, by way of example, the four Fourier coefficient computing units 602a to 605a and the four PID control units 607a to 610a, the q-axis current pulsation computing unit 408a is not limited to having such configuration. The q-axis current pulsation computing unit 408a may include six Fourier coefficient computing units and six PID control units, or may include eight or more Fourier coefficient computing units and eight or more PID control units. For example, when the q-axis current pulsation computing unit 408a includes six Fourier coefficient computing units and six PID control units, the q-axis current pulsation computing unit 408a performs control of a sin 6f component and a cos 6f component in addition to the foregoing four frequency components. Alternatively, when the q-axis current pulsation computing unit 408a includes eight Fourier coefficient computing units and eight PID control units, the q-axis current pulsation computing unit 408a performs control of the sin 6f component, the cos 6f component, a sin 8f component, and a cos 8f component in addition to the foregoing four frequency components.

FIG. 8 is a flowchart illustrating an operation of the q-axis current pulsation computing unit 408a of the control unit 400a of the power converting apparatus 1 according to the second embodiment. In the q-axis current pulsation computing unit 408a, the subtraction unit 601a computes a deviation between the command value “0” and the DC bus voltage V_{dc} (step S21). The Fourier coefficient computing units 602a to 605a extract frequency components at multiple specific frequencies included in the deviation computed by the subtraction unit 601a (step S22). The amplitude control unit 606a determines a limiting value for limiting the amplitude value of each of the frequency components (step S23). The PID control units 607a to 610a each limit the amplitude value of a corresponding one of the frequency components extracted by the Fourier coefficient computing units 602a to 605a, using the limiting value determined by the amplitude control unit 606a (step S24). The AC restoration unit 611a generates the q-axis current pulsation command i_{qrip}*, using the frequency components obtained by the amplitude value limiting operation performed by the PID control units 607a to 610a (step S25).

A hardware configuration of the control unit 400a included in the power converting apparatus 1 will next be described. Similarly to the control unit 400 in the first embodiment, the control unit 400a is implemented by a combination of the processor 91 and the memory 92.

As described above, according to the present embodiment, the q-axis current pulsation computing unit 408a of the control unit 400a of the power converting apparatus 1 performs control that limits the amplitude for a fundamental frequency and a frequency that is a positive integer multiple of the fundamental frequency, of the pulsatile components included in the DC bus voltage V_{dc}. This enables the control unit 400a of the power converting apparatus 1 to increase accuracy of compensation in compensation control of causing the q-axis current i_{q} to pulsate. Accordingly, the power converting apparatus 1 can provide an advantage such as copper loss reduction.

### Third Embodiment

A third embodiment will be described as to a method for the amplitude control unit 606a of the q-axis current pulsation computing unit 408a to determine the limiting value to limit the amplitude value of each of the frequency components extracted by the Fourier coefficient computing units 602a to 605a when the power converting apparatus 1 is to perform capacitor current reducing control. In the third embodiment, the control unit 400a is configured similarly to the control unit 400a in the second embodiment illustrated in FIG. 6.

A first technique will be first described. In the first technique, the amplitude control unit 606a uses the amplitude value of each of frequency components of the pulsation included in the DC bus voltage V_{dc}. FIG. 9 is a first block diagram illustrating an example configuration of the q-axis current pulsation computing unit 408a of the control unit 400a of the power converting apparatus 1 according to the third embodiment. The q-axis current pulsation computing unit 408a includes the subtraction unit 601a, the Fourier coefficient computing units 602a to 605a, the amplitude control unit 606a, the PID control units 607a to 610a, and the AC restoration unit 611a. The q-axis current pulsation computing unit 408a differs from that of the second embodiment in that the Fourier coefficient computing units 602a to 605a output computation results to the amplitude control unit 606a, and the amplitude control unit 606a determines the limiting value, using the limit value i_{qriplim} of the q-axis current pulsation command i_{qrip}* and the computation results from the Fourier coefficient computing units 602a to 605a. That is, on the basis of the amplitude value of each of the frequency components of the q-axis current i_{q}, the amplitude control unit 606a adjusts the amplitude value of each of the frequency components of the q-axis current i_{q} to be finally output.

The Fourier coefficient computing unit 602a obtains the amplitude value of the sin 2f component by computation and outputs the thus obtained amplitude value to the amplitude control unit 606a as well as to the PID control unit 607a. The amplitude value of the sin 2f component is herein denoted by I_{q2fs}*. The Fourier coefficient computing unit 603a obtains the amplitude value of the cos 2f component by computation and outputs the thus obtained amplitude value to the amplitude control unit 606a as well as to the PID control unit 608a. The amplitude value of the cos 2f component is herein denoted by I_{q2fc}*. The Fourier coefficient computing unit 604a obtains the amplitude value of the sin 4f component by computation and outputs the thus obtained amplitude value to the amplitude control unit 606a as well as to the PID control unit 609a. The amplitude value of the sin 4f component is herein denoted by I_{q4fs}*. The Fourier coefficient computing unit 605a obtains the amplitude value of the cos 4f component by computation and outputs the thus obtained amplitude value to the amplitude control unit 606a as well as to the PID control unit 610a. The amplitude value of the cos 2f component is herein denoted by I_{q4fc}*.

The amplitude control unit 606a computes the norm of the 2f component of the power supply frequency, as shown by Formula (1).

$$\begin{matrix}Formula 1 & \\ \sqrt{{( {I}_{q 2 fc}^{*} )}^{2} + {( {I}_{q 2 fs}^{*} )}^{2}} & ( 1 )\end{matrix}$$

The amplitude control unit 606a computes the norm of the 4f component of the power supply frequency, as shown by Formula (2).

$$\begin{matrix}Formula 2 & \\ \sqrt{{( {I}_{q 4 fc}^{*} )}^{2} + {( {I}_{q 4 fs}^{*} )}^{2}} & ( 2 )\end{matrix}$$

The amplitude control unit 606a adds together the norm of the 2f component of the power supply frequency and the norm of the 4f component of the power supply frequency, as shown by Formula (3).

$$\begin{matrix}Formula 3 & \\ \sqrt{{( {I}_{q 2 fc}^{*} )}^{2} + {( {I}_{q 2 fs}^{*} )}^{2}} + \sqrt{{( {I}_{q 4 fc}^{*} )}^{2} + {( {I}_{q 4 fs}^{*} )}^{2}} & ( 3 )\end{matrix}$$

The amplitude control unit 606a needs to prevent the norm obtained using Formula (3) from exceeding the limit value i_{qriplim} of the q-axis current pulsation command i_{qrip}*. To this end, the amplitude control unit 606a computes the limiting value, for example, as shown by the fraction portion of Formula (4).

$$\begin{matrix}Formula 4 & \\ [ \begin{matrix}{\tilde{I}}_{q 2 fc}^{*} \\ {\tilde{I}}_{q 2 fs}^{*} \\ {\tilde{I}}_{q 4 fc}^{*} \\ {\tilde{I}}_{q 4 fs}^{*}\end{matrix} ] = \frac{{I}_{qlimrip}}{\sqrt{{( {I}_{q 2 fc}^{*} )}^{2} + {( {I}_{q 2 fs}^{*} )}^{2}} + \sqrt{{( {I}_{q 4 fc}^{*} )}^{2} + {( {I}_{q 4 fs}^{*} )}^{2}}} [ \begin{matrix}{I}_{q 2 fc}^{*} \\ {I}_{q 2 fs}^{*} \\ {I}_{q 4 fc}^{*} \\ {I}_{q 4 fs}^{*}\end{matrix} ] & ( 4 )\end{matrix}$$

Note that Formula (4) represents the computation performed by the PID control units 607a to 610a. Specifically, the PID control unit 607a multiplies the computation result I_{q2fs}* obtained from the Fourier coefficient computing unit 602a, by the limiting value obtained from the amplitude control unit 606a, such that the PID control unit 607a obtains the amplitude value I_{q2fs}* (˜) of the sin 2f component having the amplitude value limited. Note that as the paragraphs describing the embodiments except for formulas cannot express the symbol “˜” as being placed over the character “I” of Formula (4), the amplitude value is expressed as I_{q2fs}* (˜) in the description of the embodiments. This also applies to other similar expressions of the amplitude values below. The PID control unit 608a multiplies the computation result I_{q2fc}* obtained from the Fourier coefficient computing unit 603a, by the limiting value obtained from the amplitude control unit 606a, such that the PID control unit 608a obtains the amplitude value I_{q2fc}* (˜) of the cos 2f component having the amplitude value limited. The PID control unit 609a multiplies the computation result I_{q4fs}* obtained from the Fourier coefficient computing unit 604a, by the limiting value obtained from the amplitude control unit 606a, such that the PID control unit 609a obtains the amplitude value I_{q4fs}* (˜) of the sin 4f component having the amplitude value limited. The PID control unit 610a multiplies the computation result I_{q4fc}* obtained from the Fourier coefficient computing unit 605a, by the limiting value obtained from the amplitude control unit 606a, such that the PID control unit 610a obtains the amplitude value I_{q4fc}* (˜) of the cos 4f component having the amplitude value limited.

As described above, in the q-axis current pulsation computing unit 408a, the Fourier coefficient computing units 602a to 605a, which are multiple Fourier coefficient computing units, output the amplitude values of the extracted frequency components to the amplitude control unit 606a. The amplitude control unit 606a computes the limiting value from the limit value i_{qriplim} for the q-axis current pulsation command i_{qrip}* and the amplitude values of the individual frequency components obtained from the individual Fourier coefficient computing units 602a to 605a. The PID control units 607a to 610a, which are multiple integral control units, each multiply, by the limiting value, the amplitude value of the frequency component extracted by the Fourier coefficient computing unit connected thereto, thereby limiting the amplitude value of that frequency component.

A second technique will next be described. In the second technique, the amplitude control unit 606a uses a phase relationship between frequency components of the pulsation included in the DC bus voltage V_{dc}. The q-axis current pulsation computing unit 408a is configured similarly to the foregoing q-axis current pulsation computing unit 408a illustrated in FIG. 9.

The Fourier coefficient computing units 602a to 605a operate similarly to the foregoing Fourier coefficient computing units 602a to 605a in the case in which the amplitude control unit 606a uses amplitude values.

The amplitude control unit 606a calculates the phase of a frequency, using the amplitude values of the sine and cosine components of a frequency component thereof among pieces of information on the amplitude values obtained from the Fourier coefficient computing units 602a to 605a. For example, the amplitude control unit 606a computes a phase θ_{2f} of a frequency 2f component as shown by Formula (5), using I_{q2fs}* and I_{q2fc}*, where I_{q2fs}* represents the amplitude value of the sin 2f component obtained from the Fourier coefficient computing unit 602a, and I_{q2fs}* represents the amplitude value of the cos 2f component obtained from the Fourier coefficient computing unit 603a.

$$\begin{matrix}Formula 5 & \\ {θ}_{2 f} = A tan ( \frac{{I}_{q 2 fs}^{*}}{{I}_{q 2 fc}^{*}} ) & ( 5 )\end{matrix}$$

The amplitude control unit 606a computes a phase θ_{4f} of a frequency 4f component by a similar calculation method, using I_{q4fs}* and I_{q4fs}*, where I_{q2fs}* represents the amplitude value of the sin 4f component obtained from the Fourier coefficient computing unit 604a, and I_{q4fc}* represents the amplitude value of the cos 4f component obtained from the Fourier coefficient computing unit 605a. Note that an additional element for computing the phase θ_{2f} and the phase θ_{4f} may be provided upstream of the amplitude control unit 606a, such that the phase Off and the phase θ_{4f} are computed outside the amplitude control unit 606a. The amplitude control unit 606a determines the limiting value for each of the frequency components from the phase relationship between the phase θ_{2f} and the phase θ_{4f}.

The reason why, on the basis of the phase relationship between frequency components of the q-axis current i_{q}, the amplitude control unit 606a adjusts the amplitude value of each of the frequency components of the q-axis current i_{q} to be finally output is that a different phase relationship between multiple pulsatile components of the q-axis current i_{q} results in a different maximum value of these frequency components added together. For example, the pulsatile component of the q-axis current i_{q} calculated from the frequency 2f component and the pulsatile component of the q-axis current i_{q} calculated from the frequency 4f component increase in current peak value when these pulsatile components are in phase, but may decrease in current peak value when these pulsatile components are out of phase. The decrease in current peak value provides the pulsatile component of the q-axis current i_{q} with a margin relative to the limit value i_{qriplim} of the q-axis current pulsation command i_{qrip}*, such that the amplitude of the corresponding pulsatile component of the q-axis current i_{q} increases accordingly to thereby reduce the amount of electrical current flowing into the capacitor 210.

FIG. 10 is a diagram illustrating an example in which the peak value differs depending on the phase difference when two frequency components are added together. FIG. 10(a) illustrates a case where the frequency components are in phase and FIG. 10(b) illustrates a case where the frequency components are out of phase. Note that FIGS. 10(a) and 10(b) is based on the assumption that the sin 2f component and the sin 4f component have the same amplitudes. FIG. 10(b) is based on the assumption that the sin 2f component and the sin 4 component differ in phase from each other by 90°, that is, the sin 4f component has an initial phase of 90°. As illustrated in FIG. 10(a), with the frequency components in phase, the amplitude of the waveform generated by adding together the sin 2f component and the sin 4f component has the maximum value of 1.76 increasing from the maximum value 1 of the sin 1f component, and the minimum value-1.76 decreasing from the minimum value-1 of the sin 1f component. Meanwhile, as illustrated in FIG. 10(b), with the frequency components out of phase, the amplitude of the waveform generated by adding together the sin 2f component and the sin 4f component has the maximum value of 1.12 increasing from the maximum value 1 of the sin 1f component, and the minimum value of −2 decreasing from the minimum value-1 of the sin 1f component. As described above, the maximum value and the minimum value vary depending on the initial phases of the sine waves to be added together. A different maximum value and a different minimum value provide a different amount of margin relative to the limit value i_{qriplim} of the q-axis current pulsation command i_{qrip}*. The amplitude control unit 606a therefore adjusts the limiting value for each of the frequency components, depending on the phase of each of the frequency components.

The relationship between the phase difference between the frequency components and the peak value of the frequency components added together can be determined in advance by, for example, the designer of the power converting apparatus 1. In addition, the degree of limitation to be imposed on the frequency components depending on the peak value of the frequency components added together can also be determined in advance by, for example, the designer of the power converting apparatus 1. Thus, storing in advance the relationship among factors such as the phase difference between the frequency components, the peak value of the frequency components added together, and the amount of limitation to be imposed on the frequency components enables the amplitude control unit 606a to determine the limiting value for each of the frequency components by determining the phase difference between the frequency components.

As described above, in the q-axis current pulsation computing unit 408a, the Fourier coefficient computing units 602a to 605a, which are multiple Fourier coefficient computing units, output the amplitude values of the extracted frequency components to the amplitude control unit 606a. The amplitude control unit 606a computes the phase of a first frequency and the phase of a second frequency from the frequency components obtained from the Fourier coefficient computing units 602a to 605a. The amplitude control unit 606a computes the phase difference between the phase of the first frequency and the phase of the second frequency, and determines the limiting value from the phase difference and the limit value i_{qriplim} for the q-axis current pulsation command i_{q}*. The PID control units 607a to 610a, which are multiple integral control units, each limit, depending on the limiting value, the amplitude value of the frequency component extracted by the Fourier coefficient computing unit connected thereto.

A third technique will next be described. In the third technique, the amplitude control unit 606a uses the magnitude of the DC component i_{qDC} of the q-axis current command i_{q}*. FIG. 11 is a second block diagram illustrating an example configuration of the q-axis current pulsation computing unit 408a of the control unit 400a of the power converting apparatus 1 according to the third embodiment. The q-axis current pulsation computing unit 408a includes the subtraction unit 601a, the Fourier coefficient computing units 602a to 605a, the amplitude control unit 606a, the PID control units 607a to 610a, and the AC restoration unit 611a. The q-axis current pulsation computing unit 408a differs from that of the second embodiment in that the amplitude control unit 606a determines the limiting value, using the limit value i_{qriplim} of the q-axis current pulsation command i_{qrip}* and the DC component i_{qDC} of the q-axis current command i_{q}*. That is, on the basis of the DC component i_{qDC} of the q-axis current command i_{q}*, the amplitude control unit 606a adjusts the amplitude value of each of the frequency components of the q-axis current i_{q} to be finally output. Note that the amplitude control unit 606a may use, instead of the DC component i_{qDC} of the q-axis current command i_{q}*, the q-axis current command i_{qDC}* output from the speed control unit 402 (not illustrated) as the DC component i_{qDC}. In addition, when the power converting apparatus 1 includes a detection unit for detecting the DC component i_{qDC} of the q-axis current command i_{q}*, the amplitude control unit 606a may use a detection value from the detection unit.

The DC component i_{qDC} of the q-axis current command i_{q}*results from load torque exerted on the motor 314, and/or the like. The DC component i_{qDC} of the q-axis current command i_{q}*is positive when the load torque is exerted in a direction the same as the rotation direction of the motor 314, and is negative when the load torque is exerted in the opposite direction thereto. For example, when the DC component i_{qDC} of the q-axis current command i_{q}* is positive, the q-axis current command i_{q}*has a decreased margin relative to a limitation value on the positive side of the q-axis current command i_{q}*, but has an increased margin relative to a limitation value on the negative side of the q-axis current command i_{q}*. When the DC component i_{qDC} of the q-axis current command i_{q}*is negative, the q-axis current command i_{q}*has an increased margin relative to a limitation value on the positive side of the q-axis current command i_{q}*, but has a decreased margin relative to a limitation value on the negative side of the q-axis current command i_{q}*. In view of the foregoing relationships, the amplitude control unit 606a needs to adjust the magnitude of the amplitude value of each of the frequency components included in the q-axis current i_{q}.

As described above, in the q-axis current pulsation computing unit 408a, the amplitude control unit 606a determines the limiting value from the DC component i_{qDC} of the q-axis current i_{q} and the limit value i_{qriplim} for the q-axis current pulsation command i_{qrip}* The PID control units 607a to 610a, which are multiple integral control units, each limit, depending on the limiting value, the amplitude value of the frequency component extracted by the Fourier coefficient computing unit connected thereto.

Note that the amplitude control unit 606a may combine the foregoing three techniques of determining the limiting value. As described above, when the maximum value and the minimum value of the frequency components added together vary depending on the relationship between the initial phases of the respective frequency components, the amount of margin of the q-axis current command i_{q}*relative to a limit value i_{qlim} of the q-axis current command i_{q}*will vary accordingly. For example, when the DC component i_{qDC} of the q-axis current command i_{q}* is positive, the sin 2f component and the sin 4f component are added together to thereby provide the smaller maximum value with a phase difference of 90° between those components than with the components in phase. This results in a margin on the positive side relative to the limit value i_{qlim} of the q-axis current command i_{q}*. The amplitude control unit 606a determines the limiting value of each of the frequency components in view of such behavior.

As described above, according to the present embodiment, the q-axis current pulsation computing unit 408a of the control unit 400a of the power converting apparatus 1 is capable of determining the limiting value, using various techniques, and is capable of determining the limiting value with high accuracy by combining various techniques.

### Fourth Embodiment

A fourth embodiment will be specifically described as to speed pulsation reducing control of the motor 314 when the pulsatile component xᵣᵢₚ is the estimated speed ωₑₛₜ.

FIG. 12 is a block diagram illustrating an example configuration of a control unit 400b of the power converting apparatus 1 according to the fourth embodiment. The control unit 400b includes a q-axis current pulsation computing unit 408b in place of the q-axis current pulsation computing unit 408 of the control unit 400 of the first embodiment illustrated in FIG. 2. Note that although not illustrated, the power converting apparatus 1 according to the fourth embodiment includes the control unit 400b in place of the control unit 400 included in the power converting apparatus 1 of the first embodiment illustrated in FIG. 1.

FIG. 13 is a block diagram illustrating an example configuration of the q-axis current pulsation computing unit 408b included in the control unit 400b of the power converting apparatus 1 according to the fourth embodiment. The q-axis current pulsation computing unit 408b includes a subtraction unit 601b, Fourier coefficient computing units 602b to 605b, an amplitude control unit 606b, PID control units 607b to 610b, and an AC restoration unit 611b.

The subtraction unit 601b functions similarly to the subtraction unit 601. The subtraction unit 601b computes a deviation between the speed command w* and the estimated speed ωₑₛₜ estimated by the rotor position estimation unit 401.

The Fourier coefficient computing units 602b to 605b function similarly to the Fourier coefficient computing units 602 to 605. In the present embodiment, the deviation computed by the subtraction unit 601b is taken as the speed pulsation of the motor 314, and the Fourier coefficient computing units 602b to 605b compute amplitudes of the sin 1f component, the cos 1f component, the sin 2f component, and the cos 2f component included in the speed pulsation of the motor 314. Note that one or more of the value “f” in the fourth embodiment, the value “f” in the second embodiment, and the value “f” in the first embodiment may be different from another, or all of the values “f” may be equal to one another. The Fourier coefficient computing units 602b to 605b each multiply the deviation by a corresponding one of detection signals having values of sin 1ωᵢₙₜ, cos 1ωᵢₙₜ, sin 2ωᵢₙₜ, and cos 2ωᵢₙₜ. Each value twice the average value of the product of the deviation, i.e., an input signal, and the corresponding one of the detection signals represents the corresponding one of the amplitude values of the sin 1f component, the cos 1f component, the sin 2f component, and the cos 2f component included in the deviation. For example, the Fourier coefficient computing unit 602b multiplies the deviation by a detection signal of sin 1ωᵢₙₜ, and computes the amplitude value of the sin 1f component of the pulsation included in the speed pulsation of the motor 314. The Fourier coefficient computing unit 603b multiplies the deviation by a detection signal of cos 1ωᵢₙₜ, and computes the amplitude value of the cos 1f component of the pulsation included in the speed pulsation of the motor 314. The Fourier coefficient computing unit 604b multiplies the deviation by a detection signal of sin 2ωᵢₙₜ, and computes the amplitude value of the sin 2f component of the pulsation included in the speed pulsation of the motor 314. The Fourier coefficient computing unit 605b multiplies the deviation by a detection signal of cos 2ωᵢₙₜ, and computes the amplitude value of the cos 2f component of the pulsation included in the speed pulsation of the motor 314. As described above, the Fourier coefficient computing units 602b to 605b, which are multiple Fourier coefficient computing units, each extract, from the deviation computed by the subtraction unit 601b, a corresponding one of a sine component of a third frequency, a cosine component of the third frequency, a sine component of a fourth frequency, and a cosine component of the fourth frequency, where the third frequency is a frequency included in the speed pulsation of the motor 314, and the fourth frequency equals the third frequency multiplied by an integer greater than or equal to 2. In the fourth embodiment, the third frequency is 1f, and the fourth frequency is 2f.

The amplitude control unit 606b functions similarly to the amplitude control unit 606. In accordance with the limit value i_{qriplim} of the q-axis current pulsation command i_{qrip}*, the amplitude control unit 606b may assign the PID control units 607b to 610b with specific amplitude values of the individual frequency components, or ratios for reducing the amplitude values of the individual frequency components extracted by the Fourier coefficient computing units 602b to 605b. The amplitude control unit 606b may store in advance the limit value i_{qriplim} of the q-axis current pulsation command i_{qrip}*. Alternatively, the amplitude control unit 606b may obtain the q-axis current command i_{qDC}* generated by the speed control unit 402, and then obtain, by computation, the limit value i_{qriplim} of the q-axis current pulsation command i_{qrip}*, using the q-axis current command i_{qDC}*. As described above, the amplitude control unit 606b determines a limiting value for limiting the amplitude value of each of the frequency components extracted by the Fourier coefficient computing units 602b to 605b.

The PID control units 607b to 610b function similarly to the PID control units 607 to 610. The PID control units 607b to 610b each perform proportional integral differential control, i.e., PID control, to bring to zero the specific frequency component of the deviation extracted by the corresponding one of the Fourier coefficient computing units 602b to 605b. As illustrated in FIG. 13, the PID control unit 607b is connected to the Fourier coefficient computing unit 602b, the PID control unit 608b is connected to the Fourier coefficient computing unit 603b, the PID control unit 609b is connected to the Fourier coefficient computing unit 604b, and the PID control unit 610b is connected to the Fourier coefficient computing unit 605b. As discussed above, the PID control units 607b to 610b, which are multiple integral control units, are each connected to a corresponding one of the Fourier coefficient computing units 602b to 605b, and each limit the amplitude value of the frequency component extracted by the Fourier coefficient computing unit connected thereto, using the limiting value determined by the amplitude control unit 606b.

The AC restoration unit 611b functions similarly to the AC restoration unit 611. To restore an AC value from the outputs from the PID control units 607b to 610b, the AC restoration unit 611b multiplies each of the outputs from the PID control units 607b to 610b by a corresponding one of sin 1ωᵢₙₜ, cos 1ωᵢₙₜ, sin 2ωᵢₙₜ, and cos 2ωᵢₙₜ, and calculates a sum of the resulting products to thus generate the q-axis current pulsation command i_{qrip}*. As described above, the AC restoration unit 611b generates a signal having an AC component, using the frequency components obtained by amplitude value limiting operation performed by the PID control units 607b to 610b, and outputs the signal having the AC component as the q-axis current pulsation command i_{qrip}* for controlling the amplitude of the q-axis current pulsation i_{qrip}.

Although the q-axis current pulsation computing unit 408b in the present embodiment includes, by way of example, the four Fourier coefficient computing units 602b to 605b and the four PID control units 607b to 610b, the q-axis current pulsation computing unit 408b is not limited to having such configuration. The q-axis current pulsation computing unit 408b may include six Fourier coefficient computing units and six PID control units, or may include eight or more Fourier coefficient computing units and eight or more PID control units. For example, when the q-axis current pulsation computing unit 408b includes six Fourier coefficient computing units and six PID control units, the q-axis current pulsation computing unit 408b performs control of a sin 3f component and a cos 3f component in addition to the foregoing four frequency components. Alternatively, when the q-axis current pulsation computing unit 408b includes eight Fourier coefficient computing units and eight PID control units, the q-axis current pulsation computing unit 408b performs control of the sin 3f component, the cos 3f component, a sin 4f component, and a cos 4f component in addition to the foregoing four frequency components.

FIG. 14 is a flowchart illustrating an operation of the q-axis current pulsation computing unit 408b of the control unit 400b of the power converting apparatus 1 according to the fourth embodiment. In the q-axis current pulsation computing unit 408b, the subtraction unit 601b computes a deviation between the speed command ω* and the estimated speed ωₑₛₜ (step S31). The Fourier coefficient computing units 602b to 605b extract frequency components at multiple specific frequencies included in the deviation computed by the subtraction unit 601b (step S32). The amplitude control unit 606b determines a limiting value for limiting the amplitude value of each of the frequency components (step S33). The PID control units 607b to 610b each limit the amplitude value of a corresponding one of the frequency components extracted by the Fourier coefficient computing units 602b to 605b, using the limiting value determined by the amplitude control unit 606b (step S34). The AC restoration unit 611b generates the q-axis current pulsation command i_{qrip}*, using the frequency components obtained by the amplitude value limiting operation performed by the PID control units 607b to 610b (step S35).

A hardware configuration of the control unit 400b included in the power converting apparatus 1 will next be described. Similarly to the control unit 400 in the first embodiment, the control unit 400b is implemented by a combination of the processor 91 and the memory 92.

As described above, according to the present embodiment, the q-axis current pulsation computing unit 408b of the control unit 400b of the power converting apparatus 1 performs control that limits the amplitudes for a fundamental frequency and a frequency that is a positive integer multiple of the fundamental frequency, of the pulsatile components included in the estimated speed ωₑₛₜ. This enables the control unit 400b of the power converting apparatus 1 to increase accuracy of compensation in compensation control of causing the q-axis current i_{q} to pulsate. Accordingly, the power converting apparatus 1 can provide an advantage such as copper loss reduction.

### Fifth Embodiment

A fifth embodiment will be described as to a method for the amplitude control unit 606b of the q-axis current pulsation computing unit 408b to determine the limiting value to limit the amplitude value of each of the frequency components extracted by the Fourier coefficient computing units 602b to 605b when the power converting apparatus 1 is to perform motor 314 speed pulsation reducing control. In the fifth embodiment, the control unit 400b is configured similarly to the control unit 400b in the fourth embodiment illustrated in FIG. 12.

A first technique will be first described. In the first technique, the amplitude control unit 606b uses the amplitude value of each of frequency components of the pulsation included in the speed pulsation of the motor 314. FIG. 15 is a first block diagram illustrating an example configuration of the q-axis current pulsation computing unit 408b of the control unit 400b of the power converting apparatus 1 according to the fifth embodiment. The q-axis current pulsation computing unit 408b includes the subtraction unit 601b, the Fourier coefficient computing units 602b to 605b, the amplitude control unit 606b, the PID control units 607b to 610b, and the AC restoration unit 611b. The q-axis current pulsation computing unit 408b differs from that of the fourth embodiment in that the Fourier coefficient computing units 602b to 605b output computation results to the amplitude control unit 606b, and the amplitude control unit 606b determines the limiting value, using the limit value i_{qriplim} of the q-axis current pulsation command i_{qrip}* and the computation results from the respective Fourier coefficient computing units 602b to 605b. That is, on the basis of the amplitude value of each of the frequency components of the q-axis current i_{q}, the amplitude control unit 606b adjusts the amplitude value of each of the frequency components of the q-axis current i_{q} to be finally output. A specific operation of the q-axis current pulsation computing unit 408b is similar to the operation of the q-axis current pulsation computing unit 408a described in relation to the first technique of the third embodiment, and detailed description thereof will therefore be omitted.

In the q-axis current pulsation computing unit 408b, the Fourier coefficient computing units 602b to 605b, which are multiple Fourier coefficient computing units, output the amplitude values of the extracted frequency components to the amplitude control unit 606b. The amplitude control unit 606b computes the limiting value from the limit value i_{qriplim} for the q-axis current pulsation command i_{qrip}* and the amplitude values of the individual frequency components obtained from the individual Fourier coefficient computing units 602b to 605b. The PID control units 607b to 610b, which are multiple integral control units, each multiply, by the limiting value, the amplitude value of the frequency component extracted by the Fourier coefficient computing unit connected thereto, thereby limiting the amplitude value of that frequency component.

A second technique will next be described. In the second technique, the amplitude control unit 606b uses a phase relationship between frequency components of the pulsation included in the speed pulsation of the motor 314. The q-axis current pulsation computing unit 408b is configured similarly to the foregoing q-axis current pulsation computing unit 408b illustrated in FIG. 15. A specific operation of the q-axis current pulsation computing unit 408b is similar to the operation of the q-axis current pulsation computing unit 408a described in relation to the second technique of the third embodiment, and detailed description thereof will therefore be omitted.

In the q-axis current pulsation computing unit 408b, the Fourier coefficient computing units 602b to 605b, which are multiple Fourier coefficient computing units, output the amplitude values of the extracted frequency components to the amplitude control unit 606b. The amplitude control unit 606b computes the phase of a third frequency and the phase of a fourth frequency from the frequency components obtained from the multiple Fourier coefficient computing units 602b to 605b. The amplitude control unit 606b computes the phase difference between the phase of the third frequency and the phase of the fourth frequency, and determines the limiting value from the phase difference and the limit value i_{qriplim} for the q-axis current pulsation command i_{qrip}*. The PID control units 607b to 610b, which are multiple integral control units, each limit, depending on the limiting value, the amplitude value of the frequency component extracted by the Fourier coefficient computing unit connected thereto.

A third technique will next be described. In the third technique, the amplitude control unit 606b uses the magnitude of the DC component i_{qDC} of the q-axis current command i_{q}*. FIG. 16 is a second block diagram illustrating an example configuration of the q-axis current pulsation computing unit 408b of the control unit 400b of the power converting apparatus 1 according to the fifth embodiment. The q-axis current pulsation computing unit 408b includes the subtraction unit 601b, the Fourier coefficient computing units 602b to 605b, the amplitude control unit 606b, the PID control units 607b to 610b, and the AC restoration unit 611b. The q-axis current pulsation computing unit 408b differs from that of the fourth embodiment in that the amplitude control unit 606b determines the limiting value, using the limit value i_{qriplim} of the q-axis current pulsation command i_{qrip}* and the DC component i_{qDC} of the q-axis current command i_{q}*. That is, on the basis of the DC component i_{qDC} of the q-axis current command i_{q}*, the amplitude control unit 606b adjusts the amplitude value of each of the frequency components of the q-axis current i_{q} to be finally output. Note that the amplitude control unit 606b may use, instead of the DC component i_{qDC} of the q-axis current command i_{q}*, the q-axis current command i_{qDC}* output from the speed control unit 402 (not illustrated) as the DC component i_{qDC}. In addition, when the power converting apparatus 1 includes a detection unit for detecting the DC component i_{qDC} of the q-axis current command i_{q}*, the amplitude control unit 606b may use a detection value of the detection unit. A specific operation of the q-axis current pulsation computing unit 408b is similar to the operation of the q-axis current pulsation computing unit 408a described in relation to the third technique of the third embodiment, and detailed description thereof will therefore be omitted.

In the q-axis current pulsation computing unit 408b, the amplitude control unit 606b determines the limiting value from the DC component i_{qDC} of the q-axis current i_{q} and the limit value i_{qriplim} for the q-axis current pulsation command i_{qrip}*. The PID control units 607a to 610a, which are multiple integral control units, each limit, depending on the limiting value, the amplitude value of the frequency component extracted by the Fourier coefficient computing unit connected thereto.

Note that the amplitude control unit 606b may combine the foregoing three techniques of determining the limiting value.

As described above, according to the present embodiment, the q-axis current pulsation computing unit 408b of the control unit 400b of the power converting apparatus 1 is capable of determining the limiting value using various techniques, and is capable of determining the limiting value with high accuracy by combining various techniques.

### Sixth Embodiment

The second and third embodiments have been described as to the power converting apparatus 1 performing capacitor current reducing control, and the fourth and fifth embodiments have been described as to the power converting apparatus 1 performing speed pulsation reducing control of the motor 314. A sixth embodiment will be described as to the power converting apparatus 1 performing both the capacitor current reducing control and the speed pulsation reducing control of the motor 314.

FIG. 17 is a block diagram illustrating an example configuration of a control unit 400c included in the power converting apparatus 1 according to the sixth embodiment. The control unit 400c includes a q-axis current pulsation computing unit 408c in place of the q-axis current pulsation computing unit 408 of the control unit 400 of the first embodiment illustrated in FIG. 2. Note that although not illustrated, the power converting apparatus 1 according to the sixth embodiment includes the control unit 400c in place of the control unit 400 included in the power converting apparatus 1 of the first embodiment illustrated in FIG. 1.

FIG. 18 is a first block diagram illustrating an example configuration of the q-axis current pulsation computing unit 408c of the control unit 400c of the power converting apparatus 1 according to the sixth embodiment. The q-axis current pulsation computing unit 408c includes the subtraction units 601a and 601b, the Fourier coefficient computing units 602a, 603a, 602b, and 603b, an amplitude control unit 606c, the PID control units 607a, 608a, 607b, and 608b, and an AC restoration unit 611c.

The subtraction units 601a and 601b, the Fourier coefficient computing units 602a, 603a, 602b, and 603b, and the PID control units 607a, 608a, 607b, and 608b operate similarly to corresponding components described above.

The amplitude control unit 606c functions similarly to the amplitude control unit 606. The amplitude control unit 606c determines the limiting value in a manner similar to the amplitude control unit 606a or to the amplitude control unit 606b described above. Note that the amplitude control unit 606c may perform the capacitor current reducing control and the motor 314 speed pulsation reducing control with the same importance, or may place weight on one of these types of control such as increasing the limiting value in one type of control and decreasing the limiting value in another type of control.

The AC restoration unit 611c functions similarly to the AC restoration unit 611. The AC restoration unit 611c combines the outputs from the PID control units 607a, 608a, 607b, and 608b to thus generate the q-axis current pulsation command i_{qrip}*.

As described above, in the q-axis current pulsation computing unit 408c, the subtraction unit 601a, which is a first subtraction unit, computes a first deviation between the command value, which is zero, and a detection value detected by the detection unit for detecting a power state of the capacitor 210. The Fourier coefficient computing units 602a and 603a, which are multiple first Fourier coefficient computing units, each extract, from the first deviation, a corresponding one of the sine component of a first frequency and the cosine component of the first frequency, where the first frequency is twice the frequency of the first AC power. The subtraction unit 601b, which is a second subtraction unit, computes a second deviation between the speed command w* and the estimated speed ωₑₛₜ. The Fourier coefficient computing units 602b and 603b, which are multiple second Fourier coefficient computing units, each extract, from the second deviation, a corresponding one of the sine component of a third frequency and the cosine component of the third frequency, where the third frequency is a frequency included in the speed pulsation of the motor 314. The amplitude control unit 606c determines the limiting value for limiting the amplitude value of each of the frequency components extracted by the Fourier coefficient computing units 602a and 603a and the Fourier coefficient computing units 602b and 603b. The PID control units 607a and 608a, which are multiple first integral control units, are each connected to a corresponding one of the Fourier coefficient computing units 602a and 603a, and each limit, using the limiting value, the amplitude value of the frequency component extracted by the Fourier coefficient computing unit connected thereto. The PID control units 607b and 608b, which are multiple second integral control units, are each connected to a corresponding one of the Fourier coefficient computing units 602b and 603b, and each limit, using the limiting value, the amplitude value of the frequency component extracted by the Fourier coefficient computing unit connected thereto. The AC restoration unit 611c generates a signal having an AC component, using the frequency components obtained by amplitude value limiting operation performed by the PID control units 607a and 608a and the PID control units 607b and 608b, and outputs the signal having the AC component as the q-axis current pulsation command i_{qrip}* for controlling the amplitude of the q-axis current pulsation i_{qrip}.

Note that the q-axis current pulsation computing unit 408c in the example of FIG. 18 performs the capacitor current reducing control on a combination of the sine component and the cosine component of a single frequency, and performs the motor 314 speed pulsation reducing control on a combination of the sine component and the cosine component of a single frequency. However, the operation of the q-axis current pulsation computing unit 408c is not limited thereto. As described in the second through fifth embodiments, the q-axis current pulsation computing unit 408c may perform each type of control on a combination of the sine components and the cosine components of multiple frequencies.

FIG. 19 is a second block diagram illustrating an example configuration of the q-axis current pulsation computing unit 408c of the control unit 400c of the power converting apparatus 1 according to the sixth embodiment. The q-axis current pulsation computing unit 408c includes the subtraction units 601a and 601b, the Fourier coefficient computing units 602a to 605a and 602b to 605b, the amplitude control unit 606c, the PID control units 607a to 610a and 607b to 610b, and the AC restoration unit 611c.

The subtraction units 601a and 601b, the Fourier coefficient computing units 602a to 605a and 602b to 605b, and the PID control units 607a to 610a and 607b to 610b operate similarly to corresponding components described above.

The amplitude control unit 606c functions similarly to the amplitude control unit 606. The amplitude control unit 606c determines the limiting value in a manner similar to the amplitude control unit 606a or to the amplitude control unit 606b described above. Note that the amplitude control unit 606c may perform the capacitor current reducing control and the motor 314 speed pulsation reducing control with the same importance, or may place weight on one of these types of control such as increasing the limiting value in one type of control and decreasing the limiting value in another type of control.

The AC restoration unit 611c functions similarly to the AC restoration unit 611. The AC restoration unit 611c combines the outputs from the PID control units 607a to 610a and 607b to 610b to thus generate the q-axis current pulsation command i_{qrip}*.

As described above, in the q-axis current pulsation computing unit 408c, the subtraction unit 601a, which is a first subtraction unit, computes a first deviation between the command value, which is zero, and a detection value detected by the detection unit for detecting a power state of the capacitor 210. The Fourier coefficient computing units 602a to 605a, which are multiple first Fourier coefficient computing units, each extract, from the first deviation, a corresponding one of the sine component of a first frequency, the cosine component of the first frequency, the sine component of a second frequency, and the cosine component of the second frequency, where the first frequency is twice the frequency of the first AC power, and the second frequency equals the first frequency multiplied by an integer greater than or equal to 2. The subtraction unit 601b, which is a second subtraction unit, computes a second deviation between the speed command ω* and the estimated speed ωₑₛₜ. The Fourier coefficient computing units 602b to 605b, which are multiple second Fourier coefficient computing units, each extract, from the second deviation, a corresponding one of the sine component of a third frequency, the cosine component of the third frequency, the sine component of a fourth frequency, and the cosine component of the fourth frequency, where the third frequency is a frequency included in the speed pulsation of the motor 314, and the fourth frequency equals the third frequency multiplied by an integer greater than or equal to 2. The amplitude control unit 606c determines the limiting value for limiting the amplitude value of each of the frequency components extracted by the Fourier coefficient computing units 602a to 605a and the Fourier coefficient computing units 602b to 605b. The PID control units 607a to 610a, which are multiple first integral control units, are each connected to a corresponding one of the Fourier coefficient computing units 602a to 605a, and each limit, using the limiting value, the amplitude value of the frequency component extracted by the Fourier coefficient computing unit connected thereto. The PID control units 607b to 610b, which are multiple second integral control units, are each connected to a corresponding one of the Fourier coefficient computing units 602b to 605b, and each limit, using the limiting value, the amplitude value of the frequency component extracted by the Fourier coefficient computing unit connected thereto. The AC restoration unit 611c generates a signal having an AC component, using the frequency components obtained by amplitude value limiting operation performed by the PID control units 607a to 610a and the PID control units 607b to 610b, and outputs the signal having the AC component as the q-axis current pulsation command i_{qrip}* for controlling the amplitude of the q-axis current pulsation i_{qrip}.

FIG. 20 is a flowchart illustrating an operation of the q-axis current pulsation computing unit 408c of the control unit 400c of the power converting apparatus 1 according to the sixth embodiment. In the q-axis current pulsation computing unit 408c, the subtraction unit 601a computes a deviation between the command value, which is 0, and the DC bus voltage V_{dc} (step S41). The subtraction unit 601b computes a deviation between the speed command ω* and the estimated speed ωₑₛₜ (step S42). The Fourier coefficient computing units 602a to 605a extract frequency components at multiple specific frequencies included in the deviation computed by the subtraction unit 601a, and the Fourier coefficient computing units 602b to 605b extract frequency components at multiple specific frequencies included in the deviation computed by the subtraction unit 601b (step S43). The amplitude control unit 606c determines a limiting value for limiting the amplitude value of each of the frequency components (step S44). The PID control units 607a to 610a each limit the amplitude value of a corresponding one of the frequency components extracted by the Fourier coefficient computing units 602a to 605a, using the limiting value determined by the amplitude control unit 606c, and the PID control units 607b to 610b each limit the amplitude value of a corresponding one of the frequency components extracted by the Fourier coefficient computing units 602b to 605b, using the limiting value determined by the amplitude control unit 606c (step S45). The AC restoration unit 611c generates the q-axis current pulsation command i_{qrip}* using the frequency components obtained by the amplitude value limiting operation performed by the PID control units 607a to 610a and 607b to 610b (step S46).

A hardware configuration of the control unit 400c included in the power converting apparatus 1 will next be described. Similarly to the control unit 400 in the first embodiment, the control unit 400c is implemented by a combination of the processor 91 and the memory 92.

As described above, according to the present embodiment, the q-axis current pulsation computing unit 408c of the control unit 400c of the power converting apparatus 1 performs control that limits the amplitude of each of pulsatile components included in the DC bus voltage V_{dc} and in the estimated speed ωₑₛₜ. This enables the control unit 400c of the power converting apparatus 1 to increase accuracy of compensation in compensation control of causing the q-axis current i_{q} to pulsate. Accordingly, the power converting apparatus 1 can provide an advantage such as copper loss reduction. In addition, the q-axis current pulsation computing unit 408c performs control that limits the amplitudes for a fundamental frequency and a frequency that is a positive integer multiple of the fundamental frequency, of the pulsatile components included in the DC bus voltage V_{dc} and in the estimated speed ωₑₛₜ. This enables the control unit 400c of the power converting apparatus 1 to further increase accuracy of compensation in compensation control of causing the q-axis current i_{q} to pulsate. Accordingly, the power converting apparatus 1 can provide an advantage such as further copper loss reduction.

### Seventh Embodiment

FIG. 21 is a diagram illustrating an example configuration of a refrigeration cycle-incorporating apparatus 900 according to a seventh embodiment. The refrigeration cycle-incorporating apparatus 900 according to the seventh embodiment includes the power converting apparatus 1 described in relation to the first through sixth embodiments. The refrigeration cycle-incorporating apparatus 900 according to the seventh embodiment can be employed as a product including a refrigeration cycle, such as an air conditioner, a refrigerator, a freezer, or a heat pump water heater. Note that, in FIG. 21, components that function similarly to those in the first embodiment are designated by the same reference characters as used in the first embodiment.

The refrigeration cycle-incorporating apparatus 900 includes the compressor 315 incorporating the motor 314 according to the first embodiment, a four-way valve 902, an indoor heat exchanger 906, an expansion valve 908, and an outdoor heat exchanger 910, which are connected to each other via a refrigerant pipe 912.

The compressor 315 includes therein a compression mechanism 904 for compressing a refrigerant, and the motor 314 for driving the compression mechanism 904.

The refrigeration cycle-incorporating apparatus 900 is capable of operating in either a heating mode or a cooling mode through switching operation of the four-way valve 902. The compression mechanism 904 is driven by the motor 314, which is controlled to operate at a variable speed.

In the heating mode, the refrigerant is pressurized and discharged by the compression mechanism 904, flows through the four-way valve 902, the indoor heat exchanger 906, the expansion valve 908, the outdoor heat exchanger 910, and the four-way valve 902, and returns back to the compression mechanism 904 as indicated by the solid line arrows.

In the cooling mode, the refrigerant is pressurized and discharged by the compression mechanism 904, flows through the four-way valve 902, the outdoor heat exchanger 910, the expansion valve 908, the indoor heat exchanger 906, and the four-way valve 902, and returns back to the compression mechanism 904 as indicated by the broken line arrows.

In the heating mode, the indoor heat exchanger 906 acts as a condenser to release heat, while the outdoor heat exchanger 910 acts as an evaporator to absorb heat. In the cooling mode, the outdoor heat exchanger 910 acts as a condenser to release heat, while the indoor heat exchanger 906 acts as an evaporator to absorb heat. The expansion valve 908 depressurizes and expands the refrigerant.

The configurations described in the foregoing embodiments are merely examples. These configurations may be combined with a known other technology, and configurations of different embodiments may be combined together. Moreover, part of such configurations may be omitted and/or modified without departing from the spirit thereof.

1. A power converting apparatus comprising:
a rectifier unit rectifying first alternating-current power supplied from a commercial power supply;
a capacitor connected to an output end of the rectifier unit;
an inverter connected across the capacitor, the inverter generating second alternating-current power and outputting the second alternating-current power to a motor; and
a control unit controlling an operation of the inverter and an operation of the motor, using a dq-rotational coordinate system, the dq-rotational coordinate system rotating in synchronization with a rotor position of the motor, wherein
the control unit extracts a plurality of frequency components from a q-axis current pulsation and limits an amplitude value of each of the extracted frequency components to control an amplitude of the q-axis current pulsation, the q-axis current pulsation being a pulsatile component of a q-axis current.

2. The power converting apparatus according to claim 1, wherein
the control unit includes
a subtraction unit that computes a deviation between a command value and a detection value, the command value being zero, the detection value being detected by a detection unit for detecting a power state of the capacitor,
a plurality of Fourier coefficient computing units that each extract, from the deviation, one of a sine component of a first frequency, a cosine component of the first frequency, a sine component of a second frequency, and a cosine component of the second frequency, the first frequency being twice a frequency of the first alternating-current power, the second frequency equaling the first frequency multiplied by an integer greater than or equal to 2,
an amplitude control unit that determines a limiting value for limiting an amplitude value of each of frequency components extracted by the plurality of Fourier coefficient computing units,
a plurality of integral control units each connected to a corresponding one of the plurality of Fourier coefficient computing units, the plurality of integral control units each limiting, using the limiting value, the amplitude value of the frequency component extracted by the corresponding one of the Fourier coefficient computing units connected thereto, and
an alternating-current restoration unit that generates a signal having an alternating-current component, using individual frequency components obtained by amplitude value limiting operation performed by the plurality of integral control units, and outputs the signal having the alternating-current component as a q-axis current pulsation command for controlling the amplitude of the q-axis current pulsation.

3. The power converting apparatus according to claim 2, wherein
the plurality of Fourier coefficient computing units output the amplitude values of the extracted frequency components to the amplitude control unit,
the amplitude control unit computes the limiting value from a limit value for the q-axis current pulsation command and the amplitude values of the individual frequency components obtained from the plurality of Fourier coefficient computing units, and
the plurality of integral control units each multiply, by the limiting value, the amplitude value of the frequency component extracted by the corresponding one of the Fourier coefficient computing units connected thereto to limit the amplitude value of that frequency component.

4. The power converting apparatus according to claim 2, wherein
the plurality of Fourier coefficient computing units output the amplitude values of the extracted frequency components to the amplitude control unit,
the amplitude control unit computes a phase of the first frequency and a phase of the second frequency from the frequency components obtained from the plurality of Fourier coefficient computing units, computes a phase difference between the phase of the first frequency and the phase of the second frequency, and determines the limiting value from the phase difference and a limit value for the q-axis current pulsation command, and
the plurality of integral control units each limit, depending on the limiting value, the amplitude value of the frequency component extracted by the corresponding one of the Fourier coefficient computing units connected thereto.

5. The power converting apparatus according to claim 2, wherein
the amplitude control unit determines the limiting value from a direct-current component of the q-axis current and a limit value for the q-axis current pulsation command, and
the plurality of integral control units each limit, depending on the limiting value, the amplitude value of the frequency component extracted by the corresponding one of the Fourier coefficient computing units connected thereto.

6. The power converting apparatus according to claim 1, wherein
the control unit includes
a subtraction unit that computes a deviation between a speed command and an estimated speed,
a plurality of Fourier coefficient computing units that each extract, from the deviation, one of a sine component of a third frequency, a cosine component of the third frequency, a sine component of a fourth frequency, and a cosine component of the fourth frequency, the third frequency being a frequency included in a speed pulsation of the motor, the fourth frequency equaling the third frequency multiplied by an integer greater than or equal to 2,
an amplitude control unit that determines a limiting value for limiting an amplitude value of each of frequency components extracted by the plurality of Fourier coefficient computing units,
a plurality of integral control units each connected to a corresponding one of the plurality of Fourier coefficient computing units, the plurality of integral control units each limiting, using the limiting value, the amplitude value of the frequency component extracted by the corresponding one of the Fourier coefficient computing units connected thereto, and
an alternating-current restoration unit that generates a signal having an alternating-current component, using individual frequency components obtained by amplitude value limiting operation performed by the plurality of integral control units, and outputs the signal having the alternating-current component as a q-axis current pulsation command for controlling the amplitude of the q-axis current pulsation.

7. The power converting apparatus according to claim 6, wherein
the plurality of Fourier coefficient computing units output the amplitude values of the extracted frequency components to the amplitude control unit,
the amplitude control unit computes the limiting value from a limit value for the q-axis current pulsation command and the amplitude values of the individual frequency components obtained from the plurality of Fourier coefficient computing units, and
the plurality of integral control units each multiply, by the limiting value, the amplitude value of the frequency component extracted by the corresponding one of the Fourier coefficient computing units connected thereto to limit the amplitude value of that frequency component.

8. The power converting apparatus according to claim 6, wherein
the plurality of Fourier coefficient computing units output the amplitude values of the extracted frequency components to the amplitude control unit,
the amplitude control unit computes a phase of the third frequency and a phase of the fourth frequency from the frequency components obtained from the plurality of Fourier coefficient computing units, computes a phase difference between the phase of the third frequency and the phase of the fourth frequency, and determines the limiting value from the phase difference and a limit value for the q-axis current pulsation command, and
the plurality of integral control units each limit, depending on the limiting value, the amplitude value of the frequency component extracted by the corresponding one of the Fourier coefficient computing units connected thereto.

9. The power converting apparatus according to claim 6, wherein
the amplitude control unit determines the limiting value from a direct-current component of the q-axis current and a limit value for the q-axis current pulsation command, and
the plurality of integral control units each limit, depending on the limiting value, the amplitude value of the frequency component extracted by the corresponding one of the Fourier coefficient computing units connected thereto.

10. The power converting apparatus according to claim 1, wherein
the control unit includes
a first subtraction unit that computes a first deviation between a command value and a detection value, the command value being zero, the detection value being detected by a detection unit for detecting a power state of the capacitor,
a plurality of first Fourier coefficient computing units that each extract, from the first deviation, one of a sine component of a first frequency and a cosine component of the first frequency, the first frequency being twice a frequency of the first alternating-current power,
a second subtraction unit that computes a second deviation between a speed command and an estimated speed,
a plurality of second Fourier coefficient computing units that each extract, from the second deviation, one of a sine component of a third frequency and a cosine component of the third frequency, the third frequency being a frequency included in a speed pulsation of the motor,
an amplitude control unit that determines a limiting value for limiting an amplitude value of each of frequency components extracted by the first Fourier coefficient computing units and the second Fourier coefficient computing units,
a plurality of first integral control units each connected to a corresponding one of the plurality of first Fourier coefficient computing units, the plurality of first integral control units each limiting, using the limiting value, the amplitude value of the frequency component extracted by the corresponding one of the first Fourier coefficient computing units connected thereto,
a plurality of second integral control units each connected to a corresponding one of the plurality of second Fourier coefficient computing units, the plurality of second integral control units each limiting, using the limiting value, the amplitude value of the frequency component extracted by the corresponding one of the second Fourier coefficient computing units connected thereto, and
an alternating-current restoration unit that generates a signal having an alternating-current component, using frequency components obtained by amplitude value limiting operation performed by the plurality of first integral control units and the plurality of second integral control units, and outputs the signal having the alternating-current component as a q-axis current pulsation command for controlling the amplitude of the q-axis current pulsation.

11. The power converting apparatus according to claim 1, wherein
the control unit includes
a first subtraction unit that computes a first deviation between a command value and a detection value, the command value being zero, the detection value being detected by a detection unit for detecting a power state of the capacitor,
a plurality of first Fourier coefficient computing units that each extract, from the first deviation, one of a sine component of a first frequency, a cosine component of the first frequency, a sine component of a second frequency, and a cosine component of the second frequency, the first frequency being twice a frequency of the first alternating-current power, the second frequency equaling the first frequency multiplied by an integer greater than or equal to 2,
a second subtraction unit that computes a second deviation between a speed command and an estimated speed,
a plurality of second Fourier coefficient computing units that each extract, from the second deviation, one of a sine component of a third frequency, a cosine component of the third frequency, a sine component of a fourth frequency, and a cosine component of the fourth frequency, the third frequency being a frequency included in a speed pulsation of the motor, the fourth frequency equaling the third frequency multiplied by an integer greater than or equal to 2,
an amplitude control unit that determines a limiting value for limiting an amplitude value of each of frequency components extracted by the plurality of first Fourier coefficient computing units and the plurality of second Fourier coefficient computing units,
a plurality of first integral control units each connected to a corresponding one of the plurality of first Fourier coefficient computing units, the plurality of first integral control units each limiting, using the limiting value, the amplitude value of the frequency component extracted by the corresponding one of the first Fourier coefficient computing units connected thereto,
a plurality of second integral control units each connected to a corresponding one of the plurality of second Fourier coefficient computing units, the plurality of second integral control units each limiting, using the limiting value, the amplitude value of the frequency component extracted by the corresponding one of the second Fourier coefficient computing units connected thereto, and
an alternating-current restoration unit that generates a signal having an alternating-current component, using frequency components obtained by amplitude value limiting operation performed by the plurality of first integral control units and the plurality of second integral control units, and outputs the signal having the alternating-current component as a q-axis current pulsation command for controlling the amplitude of the q-axis current pulsation.

12. A motor drive unit comprising the power converting apparatus according to claim 1.

13. A refrigeration cycle-incorporating apparatus comprising the power converting apparatus according to claim 1.
